(19) United States
(12) Patent Application Publication
(10) Pub. No.: US 2024/0294682 A1
(43) Pub. Date: Sep. 5, 2024

(54) PROCESS FOR PRODUCING POLYETHYLENE POLYMERS

(71) Applicant: BOREALIS AG, Vienna (AT)

(72) Inventors: Pascal CASTRO, Porvoo (FI); Vasileios KANELLOPOULOS, Linz (AT); Georgy KIPIANI, Porvoo (FI); Marja MUSTONEN, Porvoo (FI); Irfan SAEED, Porvoo (FI)

(21) Appl. No.: 18/573,575

(22) PCT Filed: Jun. 23, 2022
(86) PCT No.: PCT/EP2022/067176

§ 371 Date: Dec. 22, 2023

(30) Foreign Application Priority Data
Jun. 24, 2021 (EP) 21181482.7

(51) Int. Cl. C08F 210/16; C08F 2/00; C08F 2/34; C08F 4/659; C08F 4/6592

(52) U.S. Cl. CPC C08F 210/16; C08F 2/001; C08F 2/34; C08F 4/65912; C08F 4/65916; C08F 4/65927; C08F 2420/07

(57) ABSTRACT

The disclosure relates to a process for polymerising olefins, the process comprising polymerising ethylene, optionally in the presence of at least one other alpha olefin comonomer, preferably C4-C10 alpha olefin comonomer, preferably in multi stage polymerisation process configuration, in the presence of a single-site polymerisation catalyst to produce a polymer component to produce a polyethylene polymer or a polyethylene copolymer, wherein the single-site polymerisation catalyst comprises (i) a transition metal complex; (ii) a cocatalyst; and optionally (iii) a support; and is characterised by a (Weibull modulus)×(scale parameter) product equal to or higher than 40 MPa and a (Weibull modulus)/(scale parameter) ratio equal to or lower than 0.50 MPa⁻¹ wherein the Weibull modulus and the scale parameter are determined by the Weibull analysis of the compressive strength of the catalyst particles. The disclosure further relates to a single-site polymerisation catalyst, comprising (i) a transition metal complex; (ii) a cocatalyst; and optionally (iii) a support, preferably a silica support; wherein the single-site polymerisation catalyst is characterised by a (Weibull modulus)×(scale parameter) product equal to or higher than 40 MPa and a (Weibull modulus)/(scale parameter) ratio equal to or lower than 0.50 MPa⁻¹ wherein the Weibull modulus and the scale parameter are determined by the Weibull analysis of the compressive strength of the catalyst particles. The disclosure further relates to use of the single-site polymerisation catalyst in the preparation of a polyethylene polymer component, a polyethylene polymer, or a polyethylene copolymer.

### FIELD OF THE DISCLOSURE

The present disclosure relates to a process for polymerising olefins for producing polyethylene polymers and copolymers using a single-site polymerisation catalyst. In particular, the present disclosure relates to polymerising olefins, in particular in a multi-stage polymerisation process configuration, to produce a polyethylene polymer or copolymer having narrow particle size distribution. The present disclosure further concerns a single-site polymerisation catalyst.

### BACKGROUND OF THE DISCLOSURE

Compared to transition metal halides, metallocene compounds are expensive materials. High productivity polymerisation catalysts are therefore highly desirable in order to maximise the polymerisation plant throughput at a minimum catalyst feed rate. If the catalyst productivity is too low, the process will not be economically viable.

Furthermore, when operating a continuous polymerisation process such as slurry or gas phase processes, or the combination of both, it is important to avoid reactor fouling in order to minimize the disruption of operations. A major source of reactor fouling is the presence of very fine polymer particles, which tend to adhere to the process surfaces due to the static charge and start building fouling on the reactor walls. Besides, those particles tend to be entrained in gas phase reactors, thus causing severe operability issues due to sheeting or they deteriorate the operation of the peripheral units like heat exchangers and compressors. In particular, if the catalyst employed in the polymerisation process consists of highly brittle particles, there is a risk that it will fragment too rapidly under the polymerisation conditions and will create catalyst or polymer fines due to uncontrolled initial particle fragmentation. Similarly, if the active components of the catalyst system are unevenly distributed within the catalyst particle there is a risk that voids of space will be created inside the polymer particle resulting in low bulk density of the resulting polymer powder with inherent risks of low operability in the polymerisation process.

It would therefore be highly beneficial to invent a metallocene catalyst which would address the above mentioned limitations by combining high productivity in the polymerisation process with optimal particle strength in order to maintain the particle integrity across the polymerisation process, avoid the formation of fines and guarantee the production of polymer powder with high bulk density. Additionally it would be highly beneficial to invent a catalyst featuring the previously mentioned requirements while having evenly distributed active species within the support to allow a better control of the polymerisation reaction and minimise the formation of voids of space inside the polymer particle for the production of high bulk density polymer powder and increased operability.

U.S. Pat. No. 7,754,834B2 teaches that polymer particles are formed by the continuous exposure of olefin monomers to catalysts present in the polymerisation reactor where the polymer particle grows from the initial formation of “micro-particle clusters” at the active sites of the catalyst particles. As these micro-particle clusters develop, voids of space are created between the growing primary polymer particles which, ultimately represent 10 to 25% of the final polymer particle volume. The existence of these voids of space in the final polymer particles lead to reduced polymer powder bulk density. Low polymer powder bulk density is commonly associated to lowered production throughput at the polymerisation plant and operability issues such as fines formation, poor material flowability, excessive carry over and is commonly associated to mass and heat transfer limitations leading to sheeting and chunking of the polymerisation reactor.

In an attempt to reduce sheeting and/or chunking in the polymerisation reactor during operations, WO2018212852A1 discloses that olefin polymerisation catalyst compositions prepared from a having 10% to 80% in volume of pores with a pore size in the range of 300-1500 Å and/or a BET surface area of less than 700 m²/g exhibit a more uniformly distributed catalyst components throughout the support material. The distribution of the catalysts components within the support material are however only assessed as the difference of aluminium content between the surface and the inside of the catalyst by XPS which is rather a qualitative method to evaluate the actual distribution of the catalytically active components within the particle. No actual measurement of the aluminium distribution throughout the support is reported to support the claim. The inventor also claim that using the catalysts of the invention results in better controlled kinetics of the polymerisation, increased productivity, reduced formation of hollow polymer particles and increased bulk density of the polymer powder. However, only single stage bench scale gas phase polymerisation experiments are provided to exemplify the features of the invention which do not necessarily support the applicability of the invention in slurry reactors or in the combination of a series of slurry and gas phase reactors combined in a multi-stage reactor set-up.

Similarly, WO2016176135A1 teaches that poor polymerisation reactor operability often result from uneven distribution of catalyst active sites within the support pores network. The inventors claim that using supported catalyst compositions having a macropore volume up to 1.23 mL/g exhibit good catalyst flowability and provide enhanced reactor operability. There is however no polymerisation data disclosed which would permit ascertain the catalyst performance in polymerisation and the actual improvement in operability.

In a comparable attempt to reduce sheeting and/or chunking in the polymerisation reactor during operations, WO2018175071A1 discloses that olefin catalyst compositions prepared from a carrier having a macroporosity ranging from 0.15-0.50 mL/g result in increased catalyst components deposition on and/or in the support material. The inventors claim that using such supports reduces sheeting and/or chunking inside the polymerisation reactor during polymerisation. However, no indication of improvement of catalyst activity or of the resulting polymer powder bulk density is provided.

U.S. Pat. No. 7,244,785B2 discloses that when a solid polymeric compound such as an aluminoxane is used as the activator, the loading of the activator during the catalyst preparation directly influences the catalyst productivity and the resulting polymer powder bulk density: the higher the loading of the aluminoxane activator in the catalyst preparation, the higher the productivity and the bulk density. It was however reported by the inventors that fouling on the polymerisation reactor walls started to build at aluminoxane loadings higher than 6.40 mol_{MAO}/g_{silica} due to leaching of active species into the reaction medium. This fouling phenomenon at higher aluminoxane loading prevents the inventors to exploit the full potential of their catalyst system to reach maximum catalyst productivity with high bulk density of the polymer powder.

### BRIEF DESCRIPTION OF THE DISCLOSURE

An object of the present disclosure is to provide a process for ethylene polymerisation, in particular multi-stage polymerisation process, typically comprising a plurality of reactors connected in series, and a specific catalyst system for use in said processes, so as to alleviate the above disadvantages.

The object of the disclosure is achieved by a specific single-site polymerisation catalyst, use of said catalyst; a process for the polymerisation of olefins, and a polyethylene (co)polymer, which are characterized by what is stated in the independent claims. The preferred embodiments of the disclosure are disclosed in the dependent claims.

The disclosure is based on the idea of providing catalyst particles, which are able to follow replication pattern that would thus yield in polymer particles with spherical morphology and narrow particle size distribution and hence high bulk densities. This is very important for the efficient operability of the polymerisation reactors, and for reaching higher production rates; both in gas phase and/or slurry loop reactors. Therefore, it is crucial to provide a metallocene catalyst system that contributes in controlling the catalyst fragmentation in the polymerisation process that enables the growing catalyst/polymer particles to undergo smooth and controllable initial catalyst fragmentation, which in turn will yield polyethylene polymers having high polymer bulk densities. Means of controlling the catalyst particles fragmentation kinetics will lead to optimal selection of the polymerisation process conditions that in turn widen the process-operating window and provides flexibility to run the polymerisation reactors with lower risk of producing polymer particles of poor morphology (e.g., small-size particles, irregular shape, etc.).

This is achieved by providing a single-site polymerisation catalyst characterised by a (Weibull modulus)×(scale parameter) product equal to or higher than 40 MPa and a (Weibull modulus)/(scale parameter) ratio equal to or lower than 0.50 MPa⁻¹ wherein the Weibull modulus and the scale parameter are determined by the Weibull analysis of the compressive strength of the catalyst particles.

### DETAILED DESCRIPTION OF THE DISCLOSURE

The disclosure provides a process for olefin polymerisation, the process comprising polymerising ethylene, optionally in the presence of at least one other alpha olefin comonomer, preferably C4-C10 alpha olefin comonomer, preferably in a multi-stage polymerisation process configuration, in the presence of a single-site polymerisation catalyst to produce a polymer component, a polyethylene polymer, or a polyethylene copolymer,
wherein the single-site polymerisation catalyst comprises (i) a transition metal complex; (ii) a cocatalyst; and optionally (iii) a support; and
is characterised by a (Weibull modulus)×(scale parameter) product equal to or higher than 40 MPa and a (Weibull modulus)/(scale parameter) ratio equal to or lower than 0.50 MPa⁻¹ wherein the Weibull modulus and the scale parameter are determined by the Weibull analysis of the compressive strength of the catalyst particles.

The Weibull distribution is commonly used in material science to describe the variability in the fracture mechanical strength of brittle materials within a sample population. The two characteristic parameters of a Weibull analysis in compressive testing are the Weibull modulus and the compressive strength. The Weibull modulus is a dimensionless parameter, which describes the variability in the distribution of the measured compressive strength between the single particles of the sample population. The Weibull modulus corresponds to the shape parameter of the Weibull distribution. In compression testing, the scale parameter of the Weibull distribution describes the compressive strength of a representative single particle of the sample population and is expressed in MPa units. A low Weibull modulus corresponds to high variability in measured mechanical strength within the sample population and is indicative of uneven distribution of defects in the material resulting in a non-uniform breaking behaviour under stress. A high Weibull modulus on the other hand will indicate an even distribution of flaws in the material resulting in a uniform breaking behaviour under stress. A high scale parameter corresponds to a high particle strength sample. A low scale parameter corresponds to a low particle strength sample. Both parameters of the Weibull distribution are relevant to describe the final properties of the studied material, and in the case of olefin polymerisation catalyst particles both parameters will influence the polymerisation behaviour and final polymer powder properties.

When the present single-site polymerisation catalyst exhibits a (Weibull modulus)×(scale parameter) product equal to or higher than 40 MPa, preferably equal to or higher than 41 MPa, in particular from 42 to 75 MPa, and a (Weibull modulus)/(scale parameter) ratio equal to or lower than 0.50 MPa⁻¹, preferably equal to or lower than 0.49 MPa⁻¹, in particular from 0.25 to 0.49 MPa⁻¹, wherein the Weibull modulus and the scale parameter are determined by the Weibull analysis of the compressive strength of the catalyst particles, they enable high bulk density of the polymer powder in loop reactors but also after the gas phase reactor, as well as high productivity in the loop reactors and throughout the polymerisation process.

The disclosure in particular provides a for polymerising olefins in multi stage polymerisation process configuration, the process comprising
a) polymerising in a first polymerisation step ethylene, optionally in the presence of at least one other alpha olefin comonomer, preferably C4-C10 alpha olefin comonomer, and a single-site polymerisation catalyst, preferably in slurry phase, so as to form a first polymer component (A); and
b) polymerising in a second polymerisation step, olefin monomer, optionally in the presence of at least one other alpha olefin comonomer, preferably C4-C10 alpha olefin comonomer, in the presence of the first polymer component (A) of step a), preferably in gas phase, so as to form a second polymer component (B),
to produce a polyethylene polymer or a polyethylene copolymer,
wherein the single-site polymerisation catalyst comprises (i) a transition metal complex; (ii) a cocatalyst; and optionally (iii) a support; and is characterised by a (Weibull modulus)×(scale parameter) product equal to or higher than 40 MPa, preferably equal to or higher than 41 MPa, in particular from 42 to 75 MPa, and a (Weibull modulus)/(scale parameter) ratio equal to or lower than 0.50 MPa-1, preferably equal to or lower than 0.49 MPa-1, in particular from 0.25 to 0.49 MPa⁻¹, wherein the Weibull modulus and the scale parameter are determined by the Weibull analysis of the compressive strength of the catalyst particles.

The disclosure in particular provides a process for olefin polymerisation, comprising
a) polymerising in a first polymerisation step ethylene, optionally in the presence of at least one other alpha olefin comonomer, preferably C4-C10 alpha olefin comonomer, and a single-site polymerisation catalyst comprising,
(i) a metallocene complex of formula (I)

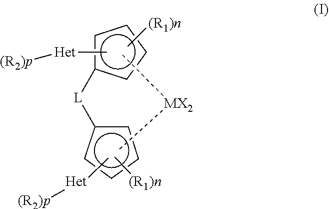

as discussed herein
(ii) a cocatalyst comprising an aluminoxane cocatalyst of formula (ii-1)

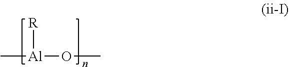

as discussed herein
and optionally of further cocatalyst comprising a compound of a group 13 element; and optionally
(iii) a support;
preferably in slurry phase, so as to form a first polymer component (A); and
b) polymerising in a second polymerisation step, olefin monomer, optionally in the presence of at least one other alpha olefin comonomer, preferably C4-C10 alpha olefin comonomer, in the presence of the first polymer component (A) of step a), preferably in gas phase, so as to form a second polymer component (B),
to produce a polyethylene polymer or a polyethylene copolymer.

The disclosure also relates to a single-site polymerisation comprising
(i) a transition metal complex;
(ii) a cocatalyst; and
optionally (iii) a support;
wherein the single-site polymerisation catalyst is characterised by a (Weibull modulus)×(scale parameter) product equal to or higher than 40 MPa, preferably equal to or higher than 41 MPa, in particular from 42 to 75 MPa, and a (Weibull modulus)/(scale parameter) ratio equal to or lower than 0.50 MPa⁻¹, preferably equal to or lower than 0.49 MPa⁻¹, in particular from 0.25 to 0.49 MPa⁻¹, wherein the Weibull modulus and the scale parameter are determined by the Weibull analysis of the compressive strength of the catalyst particles.

The disclosure in particular relates to a single-site polymerisation comprising
(i) a metallocene complex of formula (I)

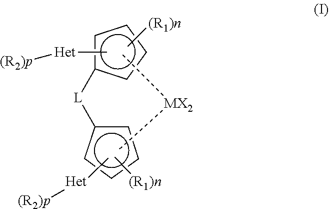

as discussed herein
(ii) a cocatalyst;
(iii) a support; and
wherein the single-site polymerisation catalyst is characterised by a (Weibull modulus)×(scale parameter) product equal to or higher than 40 MPa, preferably equal to or higher than 41 MPa, in particular from 42 to 75 MPa, and a (Weibull modulus)/(scale parameter) ratio equal to or lower than 0.50 MPa⁻¹, preferably equal to or lower than 0.49 MPa⁻¹, in particular from 0.25 to 0.49 MPa⁻¹, wherein the Weibull modulus and the scale parameter are determined by the Weibull analysis of the compressive strength of the catalyst particles.

### Process

The present disclosure relates to a process for polymerising olefins, said process comprising polymerising ethylene, optionally in the presence of at least one other alpha olefin comonomer, preferably C4-C10 alpha olefin comonomer, to produce a polyethylene polymer or a polyethylene copolymer. The process typically comprises an optional but preferred prepolymerisation step, followed by a first and a second polymerisation step.

Preferably, the same single-site polymerisation catalyst is used in each step and ideally, it is transferred from prepolymerisation to subsequent polymerisation steps in sequence in a well-known manner.

Generally, the quantity of the single-site polymerisation catalyst used will depend upon the nature of the catalyst, the reactor types and conditions and the properties desired for the polymer product. As is well known in the art hydrogen can be used for controlling the molecular weight of the polymer in any reactor.

Accordingly the present for polymerising olefins in multi stage polymerisation process configuration, the process comprising
a) polymerising in a first polymerisation step ethylene, optionally in the presence of at least one other alpha olefin comonomer, preferably C4-C10 alpha olefin comonomer, and a polymerisation catalyst, preferably in slurry phase, in the presence of a single-site polymerisation catalyst so as to form a first polymer component (A); and
b) polymerising in a second polymerisation step an olefin monomer, preferably ethylene, optionally in the presence of at least one other alpha olefin comonomer, preferably C4-C10 alpha olefin comonomer, in the presence of the first polymer component of step a), preferably in gas phase, so as to form a second polymer component (B).

One preferred process configuration is based on a Borstar® type cascade, in particular Borstar® 2G type cascade, in particular Borstar® 3G type cascade.

### Prepolymerisation Step

Polymerisation steps may be preceded by a prepolymerisation step. The purpose of the prepolymerisation is to polymerise a small amount of polymer onto the catalyst at a low temperature and/or a low monomer concentration. By prepolymerisation it is possible to improve the performance of the catalyst in slurry and/or modify the properties of the final polymer.

The prepolymerisation step may be conducted in slurry or in gas phase. Preferably prepolymerisation is conducted in slurry, preferably in a loop reactor.

The prepolymerisation is then preferably conducted in an inert diluent, preferably the diluent is a low-boiling hydrocarbon having from 1 to 6 carbon atoms or a mixture of such hydrocarbons. The temperature in the prepolymerisation step is typically from 0 to 90° C., preferably from 20 to 80° C. and more preferably from 25 to 70° C. The pressure is not critical and is typically from 1 to 150 bar, preferably from 10 to 100 bar.

The amount of polymer produced in an optional prepolymerisation step is counted to the amount (wt %) of ethylene polymer component (A).

The single-site polymerisation catalyst is introduced to the prepolymerisation step when a prepolymerisation step is present. Preferably the reaction product of the prepolymerisation step is then introduced to the first reactor.

It is understood within the scope of the invention, that the amount or polymer produced in the prepolymerisation lies within 1 to 7 wt % in respect to the final multimodal (co)polymer.

This can counted as part of the first polymer component (A) produced in the first polymerisation step a).

### First Polymerisation Step a)

In the present process the first polymerisation step a) involves polymerising ethylene monomer and optionally at least one olefin comonomer, preferably C4-C10 alpha olefin comonomer.

In one embodiment the first polymerisation step involves polymerising ethylene to produce ethylene homopolymer.

In another embodiment the first polymerisation step involves polymerising ethylene and at least one olefin comonomer to produce ethylene copolymer.

The polymerisation in the first polymerisation step a) is performed in the presence of a single-site polymerisation catalyst as discussed in detail below.

The first polymerisation step may take place in any suitable reactor or series of reactors. The first polymerisation step may take place in one or more slurry polymerisation reactor(s). Preferably the first polymerisation step takes place in one or more slurry polymerisation reactor(s), more preferably in at least three slurry-phase reactors, e.g. exactly three slurry-phase reactors, including a slurry-phase reactor for carrying out prepolymerisation.

The polymerisation in the first polymerisation zone is preferably conducted in slurry. Then the polymer particles formed in the polymerisation, together with the catalyst fragmented and dispersed within the particles, are suspended in the fluid hydrocarbon. The slurry is agitated to enable the transfer of reactants from the fluid into the particles.

The slurry polymerisation usually takes place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms or a mixture of such hydrocarbons. An especially preferred diluent is propane, possibly containing minor amount of methane, ethane and/or butane.

The ethylene content in the fluid phase of the slurry may be from 2 to about 50 mol % by, preferably from about 3 to about 20 mol % and in particular from about 5 to about 15 mol %. The benefit of having a high ethylene concentration is that the productivity of the catalyst is increased but the drawback is that more ethylene then needs to be recycled than if the concentration was lower.

The temperature in the slurry polymerisation is typically from 50 to 115° C., preferably from 60 to 110° C. and in particular from 70 to 100° C. The pressure is from 1 to 150 bar, preferably from 10 to 100 bar.

The pressure in the first polymerisation step is typically from 35 to 80 bar, preferably from 40 to 75 bar and in particular from 45 to 70 bar.

The residence time in the first polymerisation step is typically from 0.15 h to 3.0 h, preferably from 0.20 h to 2.0 h and in particular from 0.30 to 1.5 h.

It is sometimes advantageous to conduct the slurry polymerisation above the critical temperature and pressure of the fluid mixture. Such operation is described in U.S. Pat. No. 5,391,654. In such operation, the temperature is typically from 85 to 110° C., preferably from 90 to 105° C. and the pressure is from 40 to 150 bar, preferably from 50 to 100 bar.

The slurry polymerisation may be conducted in any known reactor used for slurry polymerisation. Such reactors include a continuous stirred tank reactor and a loop reactor. It is especially preferred to conduct the polymerisation in loop reactor. In loop reactors the slurry is circulated with a high velocity along a closed pipe by using a circulation pump. Loop reactors are generally known in the art and examples are given, for instance, in U.S. Pat. Nos. 4,582,816, 3,405,109, 3,324,093, EP-A-479186 and U.S. Pat. No. 5,391,654.

The slurry may be withdrawn from the reactor either continuously or intermittently. A preferred way of intermittent withdrawal is the use of settling legs where slurry is allowed to concentrate before withdrawing a batch of the concentrated slurry from the reactor. The use of settling legs is disclosed, among others, in U.S. Pat. Nos. 3,374,211, 3,242,150 and EP-A-1310295. Continuous withdrawal is disclosed, among others, in EP-A-891990, EP-A-1415999, EP-A-1591460 and WO-A-2007/025640. The continuous withdrawal is advantageously combined with a suitable concentration method, as disclosed in EP-A-1310295, EP-A-1591460 and EP3178853B1.

Hydrogen may be fed into the reactor to control the molecular weight of the polymer as known in the art. Furthermore, one or more alpha-olefin comonomers may be added into the reactor to control the density of the polymer product. The actual amount of such hydrogen and comonomer feeds depends on the catalyst that is used and the desired melt index (or molecular weight) and density (or comonomer content) of the resulting polymer.

### Second Polymerisation Step

From the first polymerisation step the first polymer component is transferred to the second polymerisation step.

The polymerisation in first polymerisation step b) is performed in the presence of a single-site polymerisation catalyst as discussed in detail below.

In the present process the second polymerisation step b) involves polymerising ethylene monomer and optionally at least one other alpha olefin comonomer, preferably C4-C10 alpha olefin comonomer.

In one embodiment the second polymerisation step involves polymerising ethylene and 1-hexene and optionally at least one olefin comonomer to produce polyethylene copolymer or ethylene terpolymer, respectively.

The second polymerisation step preferably takes place in one or more gas phase polymerisation reactor(s).

The gas phase polymerisation is typically conducted in gas-solids fluidized beds, also known as gas phase reactors (GPR). Gas solids olefin polymerisation reactors are commonly used for the polymerisation of alpha-olefins such as ethylene and propylene as they allow relative high flexibility in polymer design and the use of various catalyst systems. A common gas solids olefin polymerisation reactor variant is the fluidized bed reactor.

A gas solids olefin polymerisation reactor is a polymerisation reactor for heterophasic polymerisation of gaseous olefin monomer(s) into polyolefin powder particles, which comprises three zones: in the bottom zone the fluidization gas is introduced into the reactor; in the middle zone, which usually has a generally cylindrical shape, the olefin monomer(s) present in the fluidization gas are polymerised to form the polymer particles; in the top zone the fluidization gas is withdrawn from the reactor. In certain types of gas solids olefin polymerisation reactors a fluidization grid (also named distribution plate) separates the bottom zone from the middle zone. In certain types of gas solids olefin polymerisation reactors the top zone forms a disengaging or entrainment zone in which due to its expanding diameter compared to the middle zone the fluidization gas expands and the gas disengages from the polyolefin powder.

The dense phase denotes the area within the middle zone of the gas solids olefin polymerisation reactor with an increased bulk density due to the formation of the polymer particles. In certain types of gas solids olefin polymerisation reactors, namely fluidized bed reactors, the dense phase is formed by the fluidized bed.

The temperature in the gas phase polymerisation is typically from 40 to 120° C., preferably from 50 to 100° C., more preferably from 65 to 90° C.

The pressure in the gas phase polymerisation is typically from 3 to 40 bar, preferably from 5 to 35 bar, more preferably from 10 to 32 bar, even preferably from 15 to 30 bar.

The residence time in the gas phase polymerisation is from 1.0 h to 4.5 h, preferably from 1.5 h to 4.0 h and in particular from 2.0 to 3.5 h.

The polymer production rate in the gas phase reactor may be from 10 tn/h to 65 tn/h, preferably from 12 tn/h to 58 tn/h and in particular from 13 tn/h to 52.0 tn/h, and thus the total polymer withdrawal rate from the gas phase reactor may be from 15 tn/h to 100 tn/h, preferably from 18 tn/h to 90 tn/h and in particular from 20 tn/h to 80.0 tn/h.

The production split (% second polymer component (B)/% first polymer component (A)) may be from 0.65 to 2.5, preferably from 0.8 to 2.3, most preferably from 1.0 to 1.65.

The gas phase polymerisation may be conducted in any known reactor used for gas phase polymerisation. Such reactors include a fluidized bed reactor, a fast fluidized bed reactor or a settled bed reactor or in any combination of these. When a combination of reactors is used then the polymer is transferred from one polymerisation reactor to another.

Furthermore, a part or whole of the polymer from a polymerisation stage may be returned into a prior polymerisation stage.

It is often preferred to remove the reactants of the preceding polymerisation stage from the polymer before introducing it into the subsequent polymerisation stage. This is preferably done when transferring the polymer from one polymerisation stage to another.

### Single-Site Polymerisation Catalyst

The polymerisation catalyst utilized in the present process is a single-site polymerisation catalyst. A single-site polymerisation catalyst typically comprises (i) a transition metal complex, (ii) a cocatalyst, and optionally (iii) a support.

Preferably the first and the second polymerisation step are performed using, i.e. in the presence of, the same single-site polymerization catalyst, preferably a metallocene catalyst.

The catalyst may be transferred into the first reactor by any means known in the art. For example, it is possible to suspend the catalyst in a diluent and maintain it as a slurry, to mix the catalyst with a viscous mixture of grease and oil and feed the resultant paste into the polymerisation zone or to let the catalyst settle and introduce portions of thus obtained catalyst mud into the polymerisation.

The present process utilizes a single-site catalysis. Polyethylene copolymers made using single-site catalysis, as opposed to Ziegler Natta catalysis, have characteristic features that allow them to be distinguished from Ziegler Natta materials. In particular, the comonomer distribution is more homogeneous. This can be shown using TREF or Crystaf techniques. Catalyst residues may also indicate the catalyst used. Ziegler Natta catalysts would not contain a Zr or Hf group (IV) metal for example.

The present single-site catalyst has a (Weibull modulus)×(scale parameter) product equal to or higher than 40 MPa, preferably equal to or higher than 41 MPa, in particular from 42 to 75 MPa, and a (Weibull modulus)/(scale parameter) ratio equal to or lower than 0.50 MPa⁻¹, preferably equal to or lower than 0.49 MPa⁻¹, in particular from 0.25 to 0.49 MPa⁻¹, wherein the Weibull modulus and the scale parameter are determined by the Weibull analysis of the compressive strength of the catalyst particles.

The present single-site polymerisation catalyst preferably has a compressive strength of at least 5 MPa, preferably at least 5.5 MPa, in particular from 6 to 25 MPa, more preferably from 7 to 20 MPa, even more preferably from 7 to 15 MPa.

The compressive strength may be determined by measuring the individual crushing strength of any 10 particles or more, e.g. exactly 10 particles, by means of a compression tester typically under inert atmosphere and calculating an average value of the measurements as the compressive strength of the polymerisation catalyst. The average value of the measurements is calculated preferably after removal of statistical outliers. The crushing strength may be measured by means of a micro-compression tester MCT-510, manufactured by Shimadzu Seisakusho Ltd.

The present single-site polymerisation catalyst preferably has a ratio of the cocatalyst (ii) to the transition metal complex (i) is preferably greater than 50 mol/mol, preferably from 60 to 200 mol/mol, more preferably from 100 to 160 mol/mol.

### Transition Metal Complex (i)

The transition metal complex comprises a transition metal (M) of Group 3 to 10 of the Periodic Table (IUPAC 2007) or of an actinide or lanthanide.

The term “transition metal complex” in accordance with the present invention includes any metallocene or non-metallocene compound of a transition metal, which bears at least one organic (coordination) ligand and exhibits the catalytic activity alone or together with a cocatalyst. The transition metal compounds are well known in the art and the present invention covers compounds of metals from Group 3 to 10, e.g. Group 3 to 7, or 3 to 6, such as Group 4 to 6 of the Periodic Table, (IUPAC 2007), as well as lanthanides or actinides.

Most preferably, the transition metal complex (i) is a metallocene complex, which comprises a transition metal compound, as defined above.

The present metallocene complexes may have the structure of formula (I):

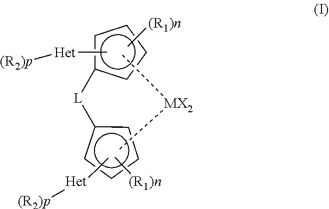

wherein each X is a sigma donor ligand;
each Het is independently a monocyclic or multicyclic heteroaromatic or heterocyclic group containing at least one heteroatom selected from O, N or S;
L is a carbon, silicon or germanium based divalent bridge in which one or two backbone atoms link the ligands; M is Ti, Zr or Hf;
each R₁ is the same or different and is a C₁₋₁₀ alkyl group, C₁₋₁₀ alkoxy, benzyl, O-benzyl, phenyl group optionally substituted by 1 to 3 C₁₋₆ alkyl groups or O-phenyl group optionally substituted by 1 to 3 C₆ alkyl groups; and/or
two adjacent R₁ groups taken together with the atoms to which they are bound form a further ring, e.g. so as to form an indenyl ring with the Cp ring, which further ring is optionally substituted by up to 4 groups R₃;
each R₃ is the same or different and is a C₁₋₁₀ alkyl group, C₁₋₁₀ alkoxy group, or phenyl group optionally substituted by 1 to 3 C₁₋₆ alkyl groups;
each n is 0 to 3;
each R₂ is the same or different and is a C₁₋₁₀ alkyl group, C₁₋₁₀ alkoxy group or —Si(R)₃ group;
each R is C₁₋₁₀ alkyl or phenyl group optionally substituted by 1 to 3 C₁₋₆ alkyl groups; and each p is 0 to 3.

The following preferred options apply to all general formulae herein.
M is preferably Zr or Hf, more preferably Zr.

Each X independently is a sigma-donor ligand. Thus each X may be the same or different, and is preferably a hydrogen atom, a halogen atom, a linear or branched, cyclic or acyclic C₁₋₂₀-alkyl or C₁₋₂₀-alkoxy group, a C₆₋₂₀-aryl group, a C₇₋₂₀-alkylaryl group or a C₇₋₂₀-arylalkyl group.

In one embodiment the X group may be trihydrocarbylsilyl, C₁₋₁₀-alkoxy, C₁₋₁₀alkoxy-C₁₋₁₀-alkyl-, or amido group.

The term halogen includes fluoro, chloro, bromo and iodo groups, preferably chloro groups.

Amido groups of interest are —NH₂, —NHC₁₋₆ alkyl or —N(C₁₋₆ alkyl)₂.

More preferably, each X is independently a hydrogen atom, a halogen atom, a C₁₋₆-alkyl, C₁₋₆-alkoxy group, amido, phenyl or benzyl group.

Yet more preferably, each X is independently a halogen atom, a linear or branched C₁₋₄-alkyl or C₁₋₄-alkoxy group, a phenyl or benzyl group.

Most preferably, each X is independently chlorine, benzyl, cyclohexyl, or a methyl group.

Preferably, both X groups are the same.

The most preferred options for both X groups are two chlorides, two methyl or two benzyl groups.

L is a bridge based on carbon, silicon or germanium. There are one to two backbone linking atoms between the two ligands, e.g. a structure such as ligand-C-ligand (one backbone atom) or ligand-Si—Si-ligand (two backbone atoms).

The bridging atoms can carry other groups. For example, suitable bridging ligands L are selected from —R′₂C—, —R′₂C—CR′₂—, —R′₂Si—, —R′₂Si—SiR′₂—, —R′₂Ge—, wherein each R′ is independently a hydrogen atom or a C₁-C₂₀-hydrocarbyl group optionally containing one or more heteroatoms of Group 14-16 of the periodic table or fluorine atoms, or optionally two R′ groups taken together can form a ring. In one embodiment R′ can be an alkyl having 1 to 10 carbon atoms substituted with alkoxy having 1 to 10 carbon atoms.

The term heteroatoms belonging to groups 14-16 of the periodic table includes for example Si, N, O or S.

Preferably L is —R′₂Si—, ethylene or methylene.

In the formula —R′₂Si—, each R′ is preferably independently a C₁-C₂₀-hydrocarbyl group. The term C₁₋₂₀-hydrocarbyl group therefore includes C₁₋₂₀-alkyl, C₂₋₂₀-alkenyl, C₂₋₂₀-alkynyl, C₃₋₂₀-cycloalkyl, C₃₋₂₀-cycloalkenyl, C₆₋₂₀-aryl groups, C₇₋₂₀-alkylaryl groups or C₇₋₂₀-arylalkyl groups or of course mixtures of these groups such as cycloalkyl substituted by alkyl. Unless otherwise stated, preferred C₁₋₂₀-hydrocarbyl groups are C₁₋₂₀-alkyl, C₂₋₂₀ alkenyl, C₄₋₂₀-cycloalkyl, C₅₋₂₀-cycloalkyl-alkyl groups, C₇₋₂₀-alkylaryl groups, C₇₋₂₀-arylalkyl groups or C₆₋₂₀-aryl groups.

In one embodiment the formula —R′₂Si—, represents silacycloalkanediyls, such as silacyclobutane, silacyclopentane, or 9-silafluorene.

Preferably, both R′ groups are the same. It is preferred if R′ is a C₁-C₁₀-hydrocarbyl, or an alkyl having 1 to 10 carbon atoms substituted with alkoxy having 1 to 10 carbon atoms.

Preferred R′ groups are methyl, ethyl, propyl, isopropyl, tert-butyl, isobutyl, C₂₋₁₀ alkenyl, C₃₋₈-cycloalkyl, cyclohexylmethyl, phenyl or benzyl, more preferably each R′ are independently a C₁-C₆-alkyl, C₂₋₁₀ alkenyl, C₅₋₆-cycloalkyl or phenyl group, and most preferably both R′ are methyl or one is methyl and the other is cyclohexyl. Most preferably the bridge is —Si(CH₃)₂—.

The Het groups can be the same or different, preferably the same. The Het group is a monocyclic or multicyclic heteroaromatic or heterocyclic group containing at least one heteroatom selected from O, N or S. If an N is present in a ring, depending on the structure of the ring, it may carry an H or C₁₋₆ alkyl group.

Preferably the Het group is monocyclic. Preferably the Het group is heteroaromatic. Preferably the Het group is a monocyclic heteroaromatic group. Preferably the Het group is a 5 or 6 membered heteroaromatic or heterocyclic ring structure.

Preferred Het groups include furanyl, tetrahydrofuranyl, thiophenyl, pyridyl, piperidinyl, or pyrrole.

It is preferred if there is one heteroatom in the Het ring. It is preferred if that heteroatom is O or S, preferably O. It is most preferred if Het is furanyl. It is preferred if the link to the cyclopentadienyl ring from the Het group is on a carbon adjacent to the heteroatom. It is preferred if the link to the Het ring from the Cp group is on a carbon adjacent to the linker L.

Each R₁ is the same or different and is a C₁₋₁₀ alkyl group, C₁₋₁₀ alkoxy, benzyl, O-benzyl (i.e. OBz), C₆₋₁₀ aryl, OC₆₋₁₀ aryl, phenyl group optionally substituted by 1 to 3 C₁₋₆ alkyl groups or O-Ph group optionally substituted by 1 to 3 C₁₋₆ alkyl groups;
and/or
two adjacent R₁ groups taken together with the atoms to which they are bound form a further ring, e.g. so as to form an indenyl ring with the Cp ring, which further ring is optionally substituted by up to 4 groups R₃.

It is preferred however if no fused ring is present and hence the ligand comprises two cyclopentadienyl rings.

Each R₁ is preferably a C₁₋₆ alkyl group, C₁₋₆ alkoxy, benzyl, phenyl group optionally substituted by 1 to 3 C₁₋₆ alkyl groups.

More preferably R₁ is a C₁₋₆ alkyl group, such as a methyl, ethyl or tert-butyl group.

The subscript “n” is preferably 1 or 2, i.e. it is preferred if the ring is substituted. If n is 2 then it is preferred if R₁ is methyl. If n is 1 then it is preferred if R₁ is t-Bu.

If n is more than 1 then it is preferred if R₁ groups are not bound to the same C atom.

If n=2 then the R₁ groups are preferably adjacent. If n=2 then the R₁ groups are preferably attached to a carbon adjacent the bridge L and the next carbon.

If n=1 then the R₁ group is preferably not adjacent to the linker L or the Het group.

Each R₂ is the same or different and is a C₁₋₁₀ alkyl group, C₁₋₁₀ alkoxy group or —Si(R)₃ group. It is preferred if R₂ is a —Si(R)₃ group.

Each R is independently a C₁₋₆ alkyl or phenyl group optionally substituted by 1 to 3 C₁₋₆ alkyl groups. Thus each R group can be the same or different.

R groups are preferably phenyl or C₁₋₄ alkyl, especially methyl or phenyl. In one embodiment one R is phenyl and the other R groups are C₁₋₄ alkyls such as methyl. In another embodiment, all R groups are C₁₋₄ alkyl groups. The use of —SiPhMe₂ or SiMe₃ is preferred.

It is preferred if p is 0 or 1, more preferably p=1.

If p is other than 0 then the R₂ substituent is preferably on a carbon adjacent the heteroatom. It is preferred if the R₂ group does not bind to the same carbon atom as the link to the Cp ring. If the Het group is furanyl then it is preferred if the Het ring is linked to the Cp ring and the Het group (if present) via the two carbons adjacent the O.

The complex of use in the invention is preferably of formula (II):

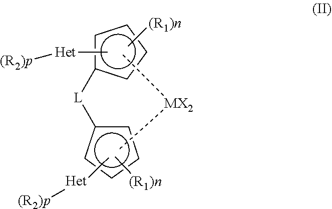

wherein each X is independently a hydrogen atom, a halogen atom, a C₁₋₆-alkyl, C₁₋₆-alkoxy group, amido, phenyl or benzyl group.;
each Het is independently a monocyclic or multicyclic heteroaromatic or heterocyclic group containing at least one heteroatom selected from O, N or S;
L is —R′₂C—, or —R′₂Si—, wherein each R′ is independently C₁₋₂₀ hydrocarbyl or C₁₋₁₀ alkyl substituted with alkoxy having 1 to 10 carbon atoms; M is Ti, Zr or Hf;
each R₁ is the same or different and is a C₁₋₁₀ alkyl group, C₁₋₁₀ alkoxy, benzyl, O-benzyl, phenyl group optionally substituted by 1 to 3 C₁₋₆ alkyl groups or O-phenyl group optionally substituted by 1 to 3 C₁₋₆ alkyl groups; and/or
two adjacent R₁ groups taken together with the atoms to which they are bound form a further ring, e.g. so as to form an indenyl ring with the Cp ring, which further ring is optionally substituted by up to 4 groups R₃;
each R₃ is the same or different and is a C₁₋₆ alkyl group, C₁₋₆ alkoxy group, or phenyl group optionally substituted by 1 to 3 C₁₋₆ alkyl groups;
each n is 0 to 3;
each R₂ is the same or different and is a C₁₋₁₀ alkyl group, C₁₋₁₀ alkoxy group or —Si(R)₃ group;
each R is C₁₋₁₀ alkyl or a phenyl group optionally substituted by 1 to 3 C₁₋₆ alkyl groups; and each p is 0 to 3.

The present metallocene complex is preferably of formula (III):

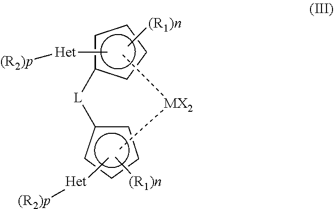

wherein each X is independently a hydrogen atom, a halogen atom, a C₁₋₆-alkyl, C₁₋₆-alkoxy group, amido, phenyl or benzyl group.;
each Het is independently a monocyclic or multicyclic heteroaromatic or heterocyclic group containing at least one heteroatom selected from O, N or S;
L is —R′₂C—, or —R′₂Si—, wherein each R′ is independently C₁₋₂₀ hydrocarbyl or C₁₋₁₀ alkyl substituted with alkoxy having 1 to 10 carbon atoms;
M is Ti, Zr or Hf;
each R₁ is the same or different and is a C₁₋₁₀ alkyl group, C₁₋₁₀ alkoxy, benzyl, O-benzyl, phenyl group optionally substituted by 1 to 3 C₁₋₆ alkyl groups or O-phenyl group optionally substituted by 1 to 3 C₁₋₆ alkyl groups;
each n is 0 to 3;
each R₂ is the same or different and is a C₁₋₆ alkyl group, C₁₋₆ alkoxy group or —Si(R)₃ group;
each R is C₁₋₆ alkyl or a phenyl group optionally substituted by 1 to 3 C₁₋₆ alkyl groups; and
each p is 0 to 3.

The present metallocene complex is preferably of formula (IV):

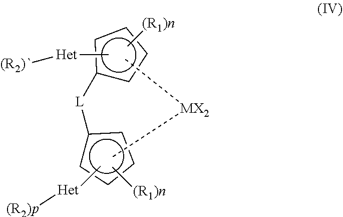

wherein each X is independently a hydrogen atom, a halogen atom, a C₁₋₆-alkyl, C₁₋₆-alkoxy group, amido, phenyl or benzyl group.;
each Het is independently a monocyclic heteroaromatic group containing at least one heteroatom selected from O, N or S;
L is —R′₂C—, or —R′₂Si—, wherein each R′ is independently C₁₋₂₀ hydrocarbyl or C₁₋₁₀ alkyl substituted with alkoxy having 1 to 10 carbon atoms;
M is Ti, Zr or Hf;
each R₁ is the same or different and is a C₁₋₆ alkyl group, or C₁₋₆ alkoxy group; each n is 0 to 3;
each R₂ is the same or different and is a C₁₋₆ alkyl group, C₁₋₆ alkoxy group or —Si(R)₃ group; each R is independently C₁₋₆ alkyl or a phenyl group optionally substituted by 1 to 3 C₁₋₆ alkyl groups; and
each p is 0 to 3.

The present metallocene complex is preferably of formula (V):

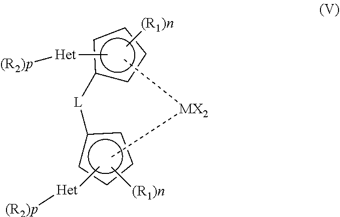

wherein each X is independently a hydrogen atom, a halogen atom, a C₁₋₆-alkyl, C₁₋₆-alkoxy group, amido, phenyl or benzyl group;
each Het is independently a monocyclic heteroaromatic or heterocyclic group containing at least one heteroatom selected from O or S;
L is —R′₂Si—, wherein each R′ is independently C₁₋₂₀ hydrocarbyl or C₁₋₁₀ alkyl substituted with alkoxy having 1 to 10 carbon atoms;
M is Ti, Zr or Hf;
each R₁ is the same or different and is a C₁₋₆ alkyl group or C₁₋₆ alkoxy group;
each n is 1 to 2;
each R₂ is the same or different and is a C₁₋₆ alkyl group, C₁₋₆ alkoxy group or —Si(R)₃ group;
each R is C₁₋₁₀ alkyl or phenyl group optionally substituted by 1 to 3 C₁₋₆ alkyl groups; and
each p is 0 to 1.

The complex of use in the invention is preferably of formula (VI):

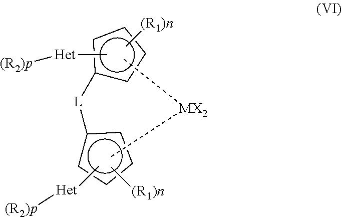

wherein each X is independently a hydrogen atom, a halogen atom, a C₁₋₆-alkyl, C₁₋₆-alkoxy group, amido, phenyl or benzyl group.;
each Het is independently a monocyclic heteroaromatic or heterocyclic group containing at least one heteroatom selected from O or S;
L is —R′₂Si—, wherein each R′ is independently C1-10 alkyl, C3-8 cycloalkyl or C2-10 alkenyl;
M is Ti, Zr or Hf;
each R₁ is the same or different and is a C₁₋₆ alkyl group;
each n is 1 to 2;
each R₂ is the same or different and is a —Si(R)₃ group;
each R is C₁₋₁₀ alkyl or phenyl group optionally substituted by 1 to 3 C₁₋₆ alkyl groups; and
each p is 0 to 1.

The present metallocene complex is preferably of formula (VII)

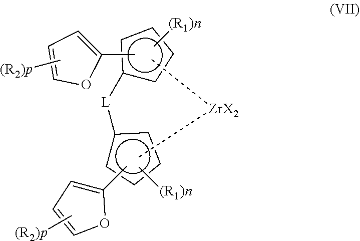

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
each R₁ is the same or different and is a C₁₋₆ alkyl group;
each n is 0 to 3;
each R₂ is the same or different and is a C₁₋₆ alkyl group or —Si(R)₃ group;
each R is C₁₋₁₀ alkyl or phenyl group optionally substituted by 1 to 3 C₁₋₆ alkyl groups; and
each p is 0 to 3.

The present metallocene complex is preferably of formula (VIII)

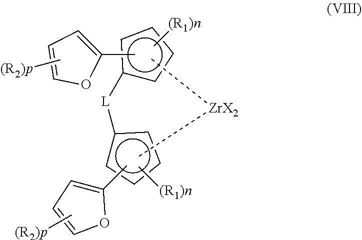

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
each R₁ is the same or different and is a C₁₋₆ alkyl group;
each n is 1 to 2;
R₂ is a —Si(R)₃ alkyl group;
each R is C₁₋₁₀ alkyl or phenyl group optionally substituted by 1 to 3 C₁₋₆ alkyl groups;
each p is 1.

The present metallocene complex is preferably of formula (IX)

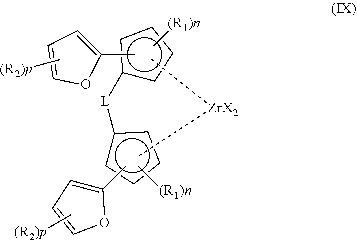

wherein each X is a sigma donor ligand such as wherein each X is independently a hydrogen atom, a halogen atom, a C₁₋₆-alkyl, C₁₋₆-alkoxy group, amido, phenyl or benzyl group;
L is a Me₂Si— or (Me)C₂₋₁₀-alkenylSi;
each R₁ is the same or different and is a C₁._alkyl group, e.g. methyl or t-Bu;
each n is 1 to 2;
R₂ is a —Si(R)₃ alkyl group;
each R is C₁₋₆ alkyl or phenyl group;
each p is 1;
such as of formula (IX′)

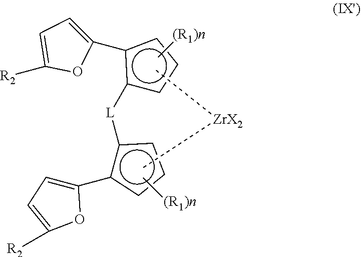

wherein each X is a sigma donor ligand such as wherein each X is independently a hydrogen atom, a halogen atom, a C₁₋₆-alkyl, C₁₋₆-alkoxy group, amido, phenyl or benzyl group;
L is a Me₂Si— or (Me)C₂₋₁₀-alkenylSi;
each R₁ is the same or different and is a C₁₋₆ alkyl group, e.g. methyl or t-Bu;
each n is 1 to 2;
R₂ is a —Si(R)₃ alkyl group;
each R is C₁₋₆ alkyl or phenyl group.

The present metallocene complex is in particular of formula (X)

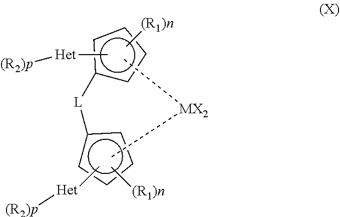

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
M is Ti, Zr or Hf;
each Het is independently a monocyclic heteroaromatic or heterocyclic group containing at least one heteroatom selected from O, N or S;
each R₁ is the same or different and is a C₁₋₁₀ alkyl group;
each n is 1 to 3;
each R₂ is the same or different and is a —Si(RaRbRc) group;
Ra is C₆ alkyl;
Rb is C₁₋₆ alkyl;
Rc is a phenyl group optionally substituted by 1 to 3 C₁₋₃ alkyl group; and
each p is 1 to 3;
such as of formula (X′)

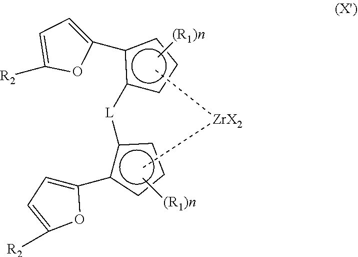

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
each R₁ is the same or different and is a C₁₋₁₀ alkyl group;
each n is 1 to 3;
each R₂ is the same or different and is a —Si(RaRbRc) group;
Ra is C₁₋₆ alkyl;
Rb is C₁₋₆ alkyl;
Rc is a phenyl group optionally substituted by 1 to 3 C₁₋₆ alkyl group.

More preferred complexes are those of formula (XI)

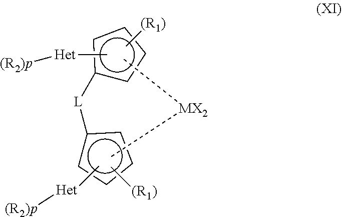

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
each Het is independently a monocyclic heteroaromatic group containing at least one heteroatom selected from O, N or S;
M is Ti, Zr or Hf;
each R₁ is the same or different and is a branched C₃₋₁₀ alkyl group;
each R₂ is the same or different and is a —Si(R)₃ group;
each R is C₁₋₁₀ alkyl or phenyl group optionally substituted by 1 to 3 C₁₋₆ alkyl groups; and each p is 1,
such as of formula (XI′)

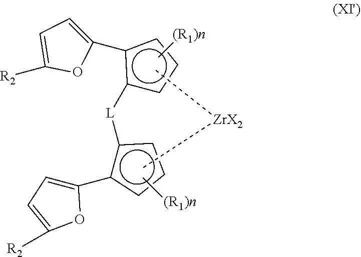

wherein each X is a sigma donor ligand such as wherein each X is independently a hydrogen atom, a halogen atom, a C₁₋₆-alkyl, C₁₋₆-alkoxy group, amido, phenyl or benzyl group;
L is a carbon, silicon or germanium based divalent bridge in which one or two backbone atoms link the ligands such as —R′₂Si—, wherein each R′ is independently C₁₋₂₀ hydrocarbyl or C₁₋₁₀ alkyl substituted with alkoxy having 1 to 10 carbon atoms;
each R₁ is the same or different and is a branched C₃₋₁₀ alkyl group;
each R₂ is the same or different and is a —Si(R)₃ group;
each R is C₁₋₁₀ alkyl or phenyl group optionally substituted by 1 to 3 C₁₋₆ alkyl groups.

Even more preferred metallocene complexes are those of formula (XII)

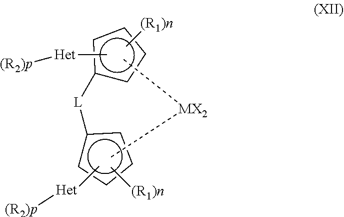

wherein each X is a sigma donor ligand such as wherein each X is independently a hydrogen atom, a halogen atom, a C₁₋₆-alkyl, C₁₋₆-alkoxy group, amido, phenyl or benzyl group;
each Het is independently a monocyclic heteroaromatic group containing at least one heteroatom selected from O, N or S;
L is a (RdRe)Si group;
Rd is a C₁₋₁₀ alkyl group;
Re is a C₂₋₁₀ alkenyl group;
M is Ti, Zr or Hf;
each R₁ is the same or different and is a C₁₋₁₀ alkyl group;
each n is 1 to 3;
each R₂ is the same or different and is a —Si(R)₃ group;
each R is C₁₋₁₀ alkyl or phenyl group optionally substituted by 1 to 3 C₁₋₆ alkyl groups; and
each p is 0 to 3,
such as of formula (XII′)

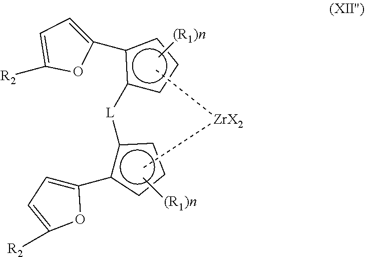

wherein each X is a sigma donor ligand such as wherein each X is independently a hydrogen atom, a halogen atom, a C₁₋₆-alkyl, C₁₋₆-alkoxy group, amido, phenyl or benzyl group;
L is a (RdRe)Si group;
Rd is a C₁₋₁₀ alkyl group;
Re is a C₂₋₁₀ alkenyl group;
each R₁ is the same or different and is a C₁₋₁₀ alkyl group;
each n is 1 to 3;
each R₂ is the same or different and is a —Si(R)₃ group;
each R is C₁₋₁₀ alkyl or phenyl group optionally substituted by 1 to 3 C₁₋₆ alkyl groups.

Highly preferred complexes are

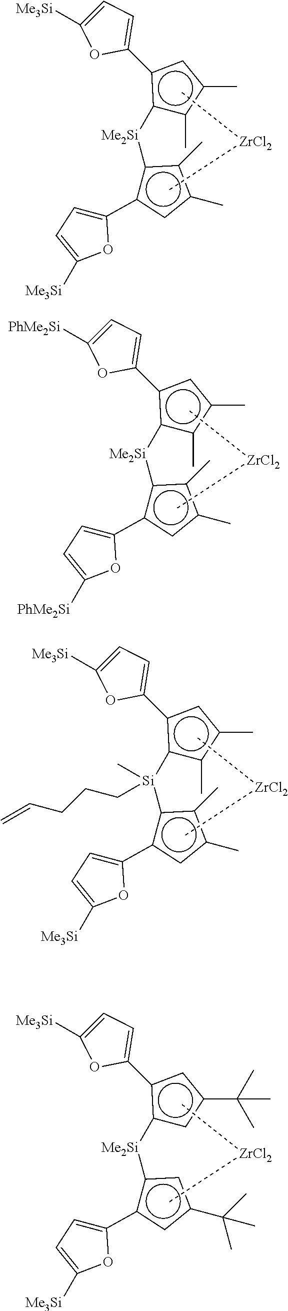

### Cocatalyst (ii)

To form an active catalytic species it is normally necessary to employ a cocatalyst as is well known in the art.

According to the present invention, a cocatalyst comprising a group 13 element is required such as a boron-containing cocatalyst or an Al containing cocatalyst. The use of an aluminoxane cocatalyst in combination with the above defined metallocene catalyst complexes is most preferred.

The aluminoxane cocatalyst can be one of formula (ii-1):

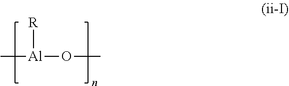

where n is from 6 to 20 and R has the meaning below.

Aluminoxanes are formed on partial hydrolysis of organoaluminum compounds, for example those of the formula AlR3, AlR2Y and Al2R3Y3 where R can be, for example, C1-C10-alkyl, preferably C1-C5-alkyl, or C3-C10-cycloalkyl, C7-C12-arylalkyl or -alkylaryl and/or phenyl or naphthyl, and where Y can be hydrogen, halogen, preferably chlorine or bromine, or C1-C10-alkoxy, preferably methoxy or ethoxy. The resulting oxygen-containing aluminoxanes are not in general pure compounds but mixtures of oligomers of the formula (ii-I).

The preferred aluminoxane is methylaluminoxane (MAO). Since the aluminoxanes used according to the invention as cocatalysts are not, owing to their mode of preparation, pure compounds, the molarity of aluminoxane solutions hereinafter is based on their aluminium content.

A boron-containing cocatalyst may also be used, optionally in combination with the aluminoxane cocatalyst.

Boron-containing cocatalysts of interest include those of formula (ii-II)

BY₃ (ii-II)
wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are fluorine, trifluoromethyl, aromatic fluorinated groups such as p-fluorophenyl, 3,5-difluorophenyl, pentafluorophenyl, 3,4,5-trifluorophenyl and 3,5-di(trifluoromethyl)phenyl. Preferred options are trifluoroborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(3,5-difluorophenyl)borane and/or tris (3,4,5-trifluorophenyl)borane.

Particular preference is given to tris(pentafluorophenyl)borane.

However it is preferred that borates are used, i.e. compounds containing a borate.

These compounds generally contain an anion of formula (ii-Ill):

(Z)4B— (ii-III)
where Z is an optionally substituted phenyl derivative, said substituent being a halo-C1-6-alkyl or halo group. Preferred options are fluoro or trifluoromethyl. Most preferably, the phenyl group is perfluorinated.

Such ionic cocatalysts preferably contain a weakly-coordinating anion such as tetrakis(pentafluorophenyl)borate or tetrakis(3,5-di(trifluoromethyl)phenyl)borate.

Suitable cationic counter-ions include triphenylcarbenium and are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
tributylammoniumtetrakis(pentafluorophenyl)borate,
tributylammoniumtetrakis(trifluoromethylphenyl)borate,
tributylammoniumtetrakis(4-fluorophenyl)borate,
N,N-dimethylcyclohexylammoniumtetrakis(pentafluorophenyl)borate,
N,N-dimethylbenzylammoniumtetrakis(pentafluorophenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakist(pentafluorophenyl)borate,
triphenylcarbeniumtetrakis(pentafluorophenyl)borate,
or ferroceniumtetrakis(pentafluorophenyl)borate.

Preference is given to triphenylcarbeniumtetrakis(pentafluorophenyl) borate,
N,N-dimethylaniliniumtetrakis(pentafluorophenyl)borate,
N,N-dimethylcyclohexylammoniumtetrakis(pentafluorophenyl)borate or
N,N-dimethylbenzylammoniumtetrakis(pentafluorophenyl)borate.

Preferred borates of use in the invention therefore comprise the trityl, i.e. triphenylcarbenium ion. Thus, the use of Ph3CB(PhF5)4 and analogues therefore are especially favoured.

Suitable amounts of cocatalyst will be well known to the person skilled in the art.

Support (iii)

It is possible to use the present polymerisation catalyst in solid but unsupported form following the protocols in WO03/051934. The present polymerisation catalyst is preferably used in solid supported form. The particulate support material used may be an inorganic porous support such as a silica, alumina or a mixed oxide such as silica-alumina, in particular silica.

The use of a silica support is preferred.

Especially preferably, the support is a porous material so that the complex may be loaded into the pores of the particulate support, e.g. using a process analogous to those described in WO94/14856, WO95/12622, WO2006/097497 and EP1828266.

The average particle size of the support such as silica support can be typically from 10 to 100 μm. Preferably the average particle size of a silica support is in from 10 to 40 μm, preferably from 15 to 35 μm. The average particle size (i.e. median particle size, D₅₀) may be determined using the laser diffraction particle size analyser Malvern Mastersizer 3000, sample dispersion: dry powder.

The average pore size of the support such as silica support can be in the range 10 to 100 nm and the pore volume from 1 to 3 mL/g.

Examples of suitable support materials are, for instance, ES757 produced and marketed by PQ Corporation, Sylopol 948 produced and marketed by Grace or SUNSPERA DM-L-303 silica produced by AGC Si-Tech Co. Supports can be optionally calcined prior to the use in catalyst preparation in order to reach optimal silanol group content.

The catalyst can contain from 5 to 500 μmol, such as 10 to 200 μmol of the transition metal complex (i) per gram of support (iii) such as silica, and 3 to 15 mmol of the cocatalyst (ii) such as MAO, per gram of support (iii) such as silica.

### Polyethylene Polymer

The present disclosure concerns the preparation of a polyethylene polymer, in particular a multimodal ethylene homopolymer or copolymer. The density of the multimodal ethylene homopolymer or copolymer may be between 900 and 980 kg/m³.

The polyethylene polymer directly provided by the present process is in the form of polymer powder.

It is preferred that the multimodal ethylene polymer is a copolymer. More preferably, the multimodal polyethylene copolymer is an LLDPE. It may have a density of 905 to 940 kg/m3, preferably 910 to 935 kg/m3, more preferably 915 to 930 kg/m3, especially of 916 to 928 kg/m3. In one embodiment a range of 910 to 928 kg/m3 is preferred. The term LLDPE used herein refers to linear low density polyethylene. The LLDPE is preferably multimodal.

The term “multimodal” includes polymers that are multimodal with respect to MFR and includes also therefore bimodal polymers. The term “multimodal” may also mean multimodality with respect to the “comonomer distribution”.

Usually, a polymer comprising at least two polyethylene fractions, which have been produced under different polymerisation conditions resulting in different (weight average) molecular weights and molecular weight distributions for the fractions, is referred to as “multimodal”. The prefix “multi” relates to the number of different polymer fractions present in the polymer. Thus, for example, the term multimodal polymer includes so called “bimodal” polymers consisting of two fractions. The form of the molecular weight distribution curve, i.e. the appearance of the graph of the polymer weight fraction as a function of its molecular weight, of a multimodal polymer, e.g. LLDPE, may show two or more maxima or at least be distinctly broadened in comparison with the curves for the individual fractions. Often the final MWD curve will be broad, skewered or displaying a shoulder.

Ideally, the molecular weight distribution curve for multimodal polymers of the invention will show two distinct maxima. Alternatively, the polymer fractions have similar MFR and are bimodal in the comonomer content. A polymer comprising at least two polyethylene fractions, which have been produced under different polymerisation conditions resulting in different comonomer content for the fractions, is also referred to as “multimodal”.

For example, if a polymer is produced in a sequential multi-stage process, utilising reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions are superimposed into the molecular weight distribution curve for the total resulting polymer product, usually yielding a curve with two or more distinct maxima.

In any multimodal polymer, there may be a lower molecular weight component (LMW) and a higher molecular weight component (HMW). The LMW component has a lower molecular weight than the higher molecular weight component. This difference is preferably at least 5000 g/mol.

The multimodal polyethylene polymer of use in the invention preferably comprises at least one C4-10-comonomer. Comonomers may be present in the HMW component (or second component) or the LMW component (or first component) or both. From hereon, the term LMW/HMW component will be used but the described embodiments apply to the first and second components respectively.

It is preferred if the HMW component comprises at least one C4-10-comonomer. The LMW component may then be an ethylene homopolymer or may also comprise at least one C4-10-comonomer. In one embodiment, the multimodal polyethylene polymer contains a single comonomer. In a preferred embodiment, the multimodal polyethylene polymer comprises at least two, e.g. exactly two, C4-10 comonomers.

In one embodiment, the multimodal polyethylene polymer is a terpolymer and comprises at least two C4-10-comonomers. In that scenario, the HMW component may be a copolymer component or terpolymer component and the lower molecular weight (LMW) component can be an ethylene homopolymer component or copolymer component. Alternatively, both LMW and HMW components can be copolymers such that at least two C4-10-comonomers are present.

The multimodal polyethylene polymer may therefore be one in which the HMW component comprises repeat units deriving from ethylene and at least two other C4-10 alpha olefin monomers such as 1-butene and one C6-10 alpha olefin monomer. Ethylene preferably forms the majority of the LMW or HMW component. In the most preferred embodiment, the LMW component may comprise an ethylene 1-butene copolymer and the HMW component may comprise an ethylene 1-hexene copolymer.

The overall comonomer content in the multimodal polyethylene polymer may be for example 0.2 to 14.0% by mol, preferably 0.3 to 12% by mol, more preferably 0.5 to 10.0% by mol and most preferably 0.6 to 8.5% by mol.

1-Butene may be present in an amount of 0.05 to 6.0% by mol, such as 0.1 to 5% by mol, more preferably 0.15 to 4.5% by mol and most preferably 0.2 to 4% by mol.

The C6 to C10 alpha olefin may be present in an amount of 0.2 to 6% by mol, preferably 0.3 to 5.5% by mol, more preferably 0.4 to 4.5% by mol.

Preferably, the LMW component has lower amount (mol %) of comonomer than the HMW component, e.g. the amount of comonomer, preferably of 1-butene in the LMW component is from 0.05 to 0.9 mol %, more preferably from 0.1 to 0.8 mol %, whereas the amount of comonomer, preferably of 1-hexene in the HMW component (B) is from 1.0 to 8.0 mol %, more preferably from 1.2 to 7.5 mol %.

If required the comonomer content (mol %) in the HMW component=(comonomer content (mol %) in final product−(weight fraction of LMW component*comonomer content (mol %) in LMW component))/(weight fraction of HMW component).

The multimodal polyethylene copolymer may therefore be formed from ethylene along with at least one of 1-butene, 1-hexene or 1-octene. The multimodal polyethylene polymer may be an ethylene butene hexene terpolymer, e.g. wherein the HMW component is an ethylene butene hexene terpolymer and the LMW is a ethylene homopolymer component. The use of a terpolymer of ethylene with 1-butene and 1-octene comonomers, or a terpolymer of ethylene with 1-octene and 1-hexene comonomers is also envisaged.

In a further embodiment, the multimodal polyethylene copolymer may comprise two polyethylene copolymers, e.g. such as two ethylene butene copolymers or an ethylene butene copolymer (e.g. as the LMW component) and an ethylene hexene copolymer (e.g. as the HMW component). It would also be possible to combine a polyethylene copolymer component and an ethylene terpolymer component, e.g. an ethylene butene copolymer (e.g. as the LMW component) and an ethylene butene hexene terpolymer (e.g. as the HMW component).

The LMW component of the multimodal polyethylene polymer may have a MFR2 of 0.5 to 3000 g/10 min, more preferably 1.0 to 1000 g/10 min. In some embodiments, the MFR2 of the LMW component may be 50 to 3000 g/10 min, more preferably 100 to 1000 g/10 min, e.g. where the target is a cast film. In some embodiments, the MFR2 of the LMW component may be 0.5 to 50 g/10 min, more preferably 1.0 to 10 g/10 min, preferably of 1.5 to 9.0 and more preferably of 2.0 to 8.5., e.g. where the target is a blown film.

The molecular weight (Mw) of the low molecular weight component should preferably range from 20,000 to 180,000, e.g. 40,000 to 160,000.

It may have a density of at least 925 kg/m³, e.g. at least 940 kg/m³. A density in the range of 930 to 950 kg/m³, preferably of 935 to 945 kg/m³ is possible.

The HMW component of the multimodal polyethylene polymer may, for example, have an MFR2 of less than 1 g/10 min, such as 0.2 to 0.9 g/10 min, preferably of 0.3 to 0.8 and more preferably of 0.4 to 0.7 g/10 min. It may have a density of less than 915 kg/m³, e.g. less than 910 kg/m³, preferably less than 905 kg/m³. The Mw of the higher molecular weight component may range from 70,000 to 1,000,000, preferably 100,000 to 500,000.

The LMW component may form 30 to 70 wt % of the multimodal polyethylene polymer such as 38 to 62 wt %, especially 45 to 55 wt %.

The HMW component may form 30 to 70 wt % of the multimodal polyethylene polymer such as 38 to 62 wt %, especially 45 to 55 wt %.

In one embodiment, there is 40 to 45 wt % of the LMW component and 60 to 55 wt % of the HMW component.

In one embodiment, the polyethylene polymer consists of the HMW and LMW components as the sole polymer components.

The multimodal polyethylene polymer of the invention may have a MFR2 of 0.01 to 50 g/10 min, preferably 0.05 to 25 g/10 min, especially 0.1 to 10 g/10 min.

The multimodal polyethylene polymer of the invention may have a density of 900 to 960 kg/m3, preferably 905 to 940 kg/m3, especially 910 to 935 kg/m3.

The molecular weight distribution (MWD, Mw/Mn) of a polyethylene terpolymer of the invention is in a range of 2.0 to 15.0, preferably in a range of 2.2 to 10.0 and more preferably in a range of 2.4 to 4.6.

The multimodal polyethylene polymer may be produced as described herein. Preferably, the multimodal polymer, is produced in at least two-stage polymerisation using, for example, two slurry reactors or two gas phase reactors, or any combinations thereof, in any order can be employed. Preferably however, the multimodal polymer is made using slurry polymerisation, e.g. in two loop reactors connected in series followed by a gas phase polymerisation in a gas phase reactor.

Preferably, the lower molecular weight polymer fraction is produced in continuously operating loop reactors, connected in series, where ethylene and any comonomers are polymerised in the presence of the polymerisation catalyst as stated above and a chain transfer agent such as hydrogen. The diluent is typically an inert aliphatic hydrocarbon, preferably isobutane or propane.

The higher molecular weight component can then be formed in a gas phase reactor using the same catalyst.

It is also possible for a further polymerisation step to be used such as a further gas phase step.

It is often preferred to remove the reactants of the preceding polymerisation stage from the polymer before introducing it into the subsequent polymerisation stage. This is preferably done when transferring the polymer from one polymerisation stage to another.

Where the higher molecular weight component is made second in a multi-stage polymerisation it is not possible to measure its properties directly. However, the skilled man is able to determine the density, MFR2, etc. of the higher molecular weight component using Hagström equation (Hagström, The Polymer Processing Society, Europe/Africa Region Meeting, Gothenburg, Sweden, Aug. 19-21, 1997):

According to said Hagström, in said equation (eq. 3), a=5.2 and b=0.7 for MFR2. Furthermore, w is the weight fraction of the other ethylene polymer component, e.g. component (A), having higher MFR. The LMW component can thus be taken as the component 1 and the HMW component as the component 2. Mlb is the MFR2 of the final polyethylene.

Polymer made in the process of the invention can be used in a variety of applications such as films, e.g. blown or cast films. They also have utility in moulding applications.

### EXAMPLES

### Experimental

### Chemicals and Raw Materials

Methylaluminoxane was purchased from Lannxess as 30 wt % MAO solution in toluene, (Axion CA 1330).

Rac-dimethylsilanediylbis{2-(5-(trimethylsilyl)furan-2-yl)-4,5-dimethylcyclopentadien-1-yl}zirconium dichloride metallocene were purchased from commercial sources.

### Comparative Example 1

Pre-treated silica is a commercial synthetic amorphous silica ES757 obtained from PQ Corp. The pre-treatment refers to silica commercial calcination at 600° C. according to a conventional PO catalyst technique.

### Catalyst Analytics and Characterisation

### Al and Zr Content in a Solid Catalyst Component by ICP-OES

In a glovebox, an aliquot of the catalyst (ca. 40 mg) is weighted into a glass weighing boat using an analytical balance. The sample is then allowed to be exposed to air overnight while being placed in a steel secondary container equipped with an air intake. Then, 5 mL of concentrated (65%) Nitric acid is used to rinse the content of the boat into an Xpress microwave oven vessel (20 mL). A sample is then subjected to microwave-assisted acid digestion using MARS 6 laboratory microwave unit with ramping to 150° C. within 20 minutes and a hold phase at 150° C. for 35 minutes. The digested sample is allowed to cool down to room temperature and then transferred into a plastic 100 mL volumetric flask. Standard solutions containing 1000 mg/L Yttrium (0.4 mL) are added. The flask is then filled up with distilled water and shaken. The solution is filtered through 0.45 μm Nylon syringe filters and subjected to analysis using Thermo iCAP 6300 ICP-OES and iTEVA software.

The instrument is calibrated for Al and Zr using a blank (a solution of 5% HNO3, prepared from concentrated Nitric acid) and six standards of 0.005 mg/L, 0.01 mg/L, 0.1 mg/L, 1 mg/L, 10 mg/L and 100 mg/L of Al and Zr in solutions. The solutions contain 5% HNO3 (from concentrated nitric acid), 4 mg/L of Y standard in distilled water. Plastic volumetric flasks are used. Curvilinear fitting and 1/concentration weighting are used for the calibration curves. Immediately before analysis, the calibration is verified and adjusted (instrument re-slope function) using the blank and the 10 mg/L Al and Zr standard which has 4 mg/L Y and 5% HNO3, from concentrated nitric acid, in distilled water. A quality control sample (QC: 1 mg/L Al; 2 mg/L Zr and 4 mg/L Y in a solution of 5% HNO3, from concentrated nitric acid, in distilled water) is run to confirm the re-slope. The QC sample is also run at the end of a scheduled analysis set.

The content for Zr is monitored using the 339.198 nm line. The content of Al is monitored via the 394.401 nm line. The Y 371.030 nm is used as the internal standard. The reported values are calculated back to the original catalyst sample using the original mass of the catalyst aliquot and the dilution volume.

### Compressive Strength

The crushing strength of the materials in the examples was determined using a MCT-510 micro-compressive tester by Shimadzu Corporation. The sample material was dispersed on lower compression plate, from where isolated particles were located and selected for measurements using optical microscope. The diameter of the particle was measured using microscope software tools. The selected sample particle was compressed with constantly increasing loading force until the particle breaks or set maximum force is reached. The crushing strength of the material was determined by the maximum compressive load at the point of particle breaking and the particle diameter. The measurements were performed in inert conditions with load speed 0.4462 mN/sec and the maximum load was 40 mN. The crushing strength of 10 randomly selected particles was measured and the compressive strength of the catalyst was reported as the average value after removal of statistical outliers.

Weibull distribution analysis was performed from the individual particles data by using a commercial statistical analysis software such as MiniTab or Origin.

### Particle Size Distribution of Catalyst Component Powder

The particle size distribution of the catalyst component was measured using a laser diffraction particle size analyser Malvern Mastersizer 3000. Sample dispersion: dry powder.

### Polymer Analytics and Characterisation

### Bulk Density

Bulk density of the polymer powder can be determined according to standard methods such as ISO 60:1977 or ASTM D1895-17.

### MFR

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR2 of polypropylene is determined at a temperature of 230° C. and a load of 2.16 kg, the MFR5 of polyethylene is measured at a temperature 190° C. and a load of 5 kg and the MFR2 of polyethylene at a temperature 190° C. and a load of 2.16 kg.

### Density

Density of polymers is measured according to ISO 1183-2/1872-2B.

### Particle Size Distribution

Particle size distribution of the polymer powder was measured in accordance with ISO 13320-1 with a Coulter LS 200 particle size analyzer. The instrument is able to measure the particle size distribution in a range of 0.4-2000 μm. The method is a laser diffraction method, where a laser beam is directed at the sample travelling in a flow-through cuvette. n-Heptane is used as the sample fluid. The polymer sample is first pre-treated by screening out particles larger than 2 mm. The screened sample is mixed with isopropanol and put in an ultra-sound device in order to separate the particles from each other. The pre-treated sample is then placed in the sample unit and analysed.

The mean, median (D50) and mode of the particle size distribution were calculated from the experimental data by using standard statistical distribution analysis methods.

The lognormal scale and location parameters of the polymer powder particle size distribution were determined by fitting a model lognormal distribution to the experimental distribution by using the following formula to calculate the probability density function for the distribution:

$$f ( x ) = \frac{{e}^{( - \frac{{( lnx - μ )}^{2}}{2 {σ}^{2}} )}}{x σ \sqrt{2 π}}$$

where σ is the scale parameter and μ is the location parameter of the lognormal distribution. The case where μ=0 and σ=1 is called the standard lognormal distribution.

### GPC

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{Z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3×Agilent-PLgel Olexis and 1×Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1 mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 10 \times {10}^{- 3} mL / g , {α}_{PS} = 0.655$$

$${K}_{PE} = 39 \times {10}^{- 3} mL / g , {α}_{PE} = 0.725$$

$${K}_{PP} = 19 \times {10}^{- 3} mL / g , {α}_{PP} = 0.725$$

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Comparative Catalyst Example 2 (CE2)—Representative Description of a 2-Steps Manufacturing Procedure

### Preparation of SiO₂/MAO:

SiO₂ (5.0 kg) was added from a feeding drum and inertized in the reactor to reach O₂ level below 2 ppm.

21.6 kg toluene was added into the reactor. Mixture was stirred (40 rpm) for 15 min prior to initiating MAO feed. 30 wt % MAO in toluene (8.53 kg) was added from a feed vessel on a balance within 85 min. Feed line was flushed with 1 kg toluene into the reactor after MAO feed was finished. The reaction mixture was heated up to 90° C. Temperature was set to 95° C. (oil circulation) when inside temperature 85° C. was reached. After 135 min heating a reaction time of 120 min followed. Next, the slurry was allowed to settle for 10 min and mother liquor was filtered off. The remaining solid was washed twice with toluene (21.6 kg). The target temperature for 30 minutes washings was 90° C. for the 1^{st} toluene wash and 60° C. for the 2^{nd} toluene wash. Settling time prior to filtering 2^{nd} and 3^{rd} toluene was 10 min. During settling of the 1st toluene wash liquid cooling of the reactor towards 60° C. was initiated. Finally MAO treated SiO₂ was dried at 60° C. (oil circulation temp) for 2 h under nitrogen flow of 2 kg/h, and for 6 h under vacuum under same nitrogen flow with stirring 5 rpm. Dried SiO₂/MAO was sampled and HC content was measured in the glove box with Sartorius Moisture Analyser, (Model MA45) using thermogravimetric method. Target HC level was <3% (actual 1.1%). After drying the reactor oil circulation temp was set to 10° C.

### Preparation of Metallocene Solution in Toluene:

Toluene (8.85 kg) was added into another reactor and stirred for 20 min at 25° C. (oil circulation temp, stirring 400 rpm). Metallocene Rac-dimethylsilanediylbis{2-(5-(trimethylsilyl)furan-2-yl)-4,5-dimethylcyclopentadien-1-yl}zirconium dichloride (0.209 g) was added with a burette followed by flushing with toluene (2 L, total toluene amount 8.4 kg). Reactor stirring speed was changed to 150 rpm for MC feeding and returned back to 400 rpm for 3 h reaction time. After reaction time the solution was transferred into a feeding vessel For the feeding to the Silica-MAO.

### Preparation of Catalyst:

Reactor temperature was set to 80° C. (oil circulation temp) and stirring 40 rpm for metallocene solution addition. The solution (target 9.06 kg, actual 8.8 kg) was added via a spray nozzle within 55 min followed by 60 min stirring time at 25° C. The resulting catalyst was stabilised at 25° C. for 12 hours. Finally, the catalyst was dried at 60° C. (oil circulation temp) for 2 h under nitrogen flow 2 kg/h, followed by 7 h under vacuum under same nitrogen flow with stirring 5 rpm. Dried catalyst was sampled and HC content was measured in the glove box with Sartorius Moisture Analyser, (Model MA45) using thermogravimetric method. Target HC level was <3%.

### Comparative Catalyst Example 3 (CE3)

Catalyst CE3 was prepared in a similar manner as CE5 except for initial loadings of raw materials and process parameters modifications according to Table 1.

### Comparative Catalyst Example 4 (CE4)

CE4 was prepared according to the same procedure as CE2 but with process modifications according to Table 2.

### Comparative Catalyst Example 5 (CE5)—Representative Description of a 1-Step Production Procedure

### Loading of SiO₂:

10 kg of silica (PQ Corporation ES757, calcined 600° C.) was added from a feeding drum and inertized in the reactor until O₂ level below 2 ppm was reached.

### Preparation of Metallocene/MAO Solution in Toluene:

30 wt % MAO in toluene (14.1 kg) was added into another reactor from a balance followed by toluene (4.0 kg) at 25° C. (oil circulation temp) and stirring 95 rpm. Stirring speed was increased 95 rpm->200 rpm after toluene addition, stirring time 30 min. Metallocene Rac-dimethylsilanediylbis{2-(5-(trimethylsilyl)furan-2-yl)-4,5-dimethylcyclopentadien-1-yl}zirconium dichloride 477 g was added from a metal cylinder followed by flushing with 4 kg toluene (total toluene amount 8.0 kg). Reactor stirring speed was changed to 95 rpm for MC feeding and returned back to 200 rpm for 3 h reaction time. After reaction time MAO/tol/MC solution was transferred into a feeding vessel.

### Preparation of Catalyst:

Reactor temperature was set to 10° C. (oil circulation temp) and stirring 40 rpm for MAO/tol/MC addition. MAO/tol/MC solution (target 22.5 kg, actual 22.2 kg) was added within 205 min followed by 60 min stirring time (oil circulation temp was set to 25° C.). After stirring “dry mixture” was stabilised for 12 h at 25° C. (oil circulation temp), stirring 0 rpm. Reactor was turned 20° (back and forth) and stirring was turned on 5 rpm for few rounds once an hour.

After stabilisation the catalyst was dried at 60° C. (oil circulation temp) for 2 h under nitrogen flow 2 kg/h, followed by 13 h under vacuum (same nitrogen flow with stirring 5 rpm). Dried catalyst was sampled and HC content was measured in the glove box with Sartorius Moisture Analyser, (Model MA45) using thermogravimetric method. Target HC level was <2% (actual 1.3%).

### Inventive Catalyst Example 1 (IE1)

Catalyst IE1 was prepared in a similar manner as CE5 except for initial loadings of raw materials and process parameters modifications according to Table 1.

### Inventive Catalyst Example 2 (IE2)

Catalyst IE2 was prepared in a similar manner as CE5 except for initial loadings of raw materials and process parameters modifications according to Table 1.

### Inventive Catalyst Example 3 (IE3)

Catalyst IE3 was prepared in a similar manner as CE5 except for initial loadings of raw materials and process parameters modifications according to Table 1.

### Inventive Catalyst Example 4 (IE4)

Catalyst IE4 was prepared in a similar manner as CE5 except for initial loadings of raw materials and process parameters modifications according to Table 1.

### Generic Bench-Scale Polymerisation Procedure: Unimodal Copolymerisation

In a 3 liters reactor, 1.5 mL of a 10% solution of triisobulyaluminium in heptane is fed under nitrogen pressure followed with 1250 mL of liquid propane at 20° C. The reactor pressure is 8.92 bar. The reactor is heated to the desired prepolymerisation temperature of 60° C. with stirring rate of 350 rpm. The pressure in the reactor is 21.95 bar.

0.2 bar of H₂ from a 500 mL vessel is filled into a feed line. Ethylene (32.6 g) and 1-Hexene (5.0 mL/3.4 g) corresponding to a pressure difference of 3.70 bar were added to the reactor through the line containing H₂. The pressure in the reactor increases to 25.65 bar.

The desired amount of catalyst (typically 25-35 mg) is weighed into catalyst feeder inside a glovebox. The catalyst feeder is attached to the polymerisation reactor and air in the line is removed by 3 repeated cycles of vacuum and N₂ filling. After inertisation of the line, the catalyst is flushed into the reactor with 100 mL of Propane, and stirring speed is increased to 550 rpm. The pressure in the reactor is about 25.61 bar.

The prepolymerisation step is continued until 2-5% of the prepoly material (roughly, it corresponds to 2-5 g of C₂ consumption) is formed at 60° C. by keeping the pressure constant by feeding Ethylene with a flow meter. Typically, it takes about 40 minutes to achieve the desired degree of prepolymerisation.

The temperature of the polymerisation reactor is raised to 85° C. resulting in the reactor pressure of 40.4 bar.

0.2 bar of H₂ from a 500 mL vessel is filled into the line. Ethylene (62.5 g) and 1-Hexene (10.0 mL/6.7 g) corresponding to a pressure difference of 6.70 bar are added into the reactor through the line containing H₂.

For the slurry polymerisation step, the reactor is stirred at 85° C. for 60 min. The pressure is kept constant by feeding Ethylene through a flow meter. After 60 min of polymerisation, the reaction is stopped by reducing the stirring to 150 rpm, venting the reactor and reducing the temperature to 60° C. For removing hydrocarbon residues (before opening)—reactor is flushed 10 times by pressurising/releasing 1 bar of Nitrogen pressure. Reactor is cooled down to 20° C. before opening it.

### Comparative Process Example 1 (CPE1/CE5)

A single-site catalyst (CE5), having an initial size (D50) of 25 μm was used to produce LLDPE film. The catalyst was first prepolymerised in a prepolymerisation reactor at T=50° C. and P=65 barg. More specifically, 900 kg/h of ethylene, 95 kg of 1-butene per tn ethylene, 0.27 Kg hydrogen per tn of propane and 6.50 tn propane/h (diluent) were fed to prepoly reactor and the mean residence time was 30 mins. The product was transferred to a split loop reactor configuration having volume equal to 80 m3. Ethylene (C2), propane (diluent), 1-butene (C4) and hydrogen (H2) were fed to the reactors and the polymerisation conditions were T=85° C., P=64 barg and the mean residence time was equal to 1.0 h. The molar ratio of H2/C2 and C4/C2 were 2 mol/kmol and 100 mol/kmol, respectively, and the overall productivity was 1.1 kg/gcat. Then, the material flashed out in a high-pressure separator, which operating pressure has been selected to be equal to 2 barg and the estimated residence time was equal to 5 mins. Subsequently, the polymer particles were transferred to the gas-phase reactor having overall volume equal to 350 m3 (including the disengagement zone) that operated at overall pressure of 20 barg, temperature of 75° C. and having gas phase composition of 52.5% mol propane, 10% mol nitrogen, 32.5% mol ethylene, 5% mol C6 and H2/C2=0.5 mol/kmol. The overall residence time in the GPR has been 3 hours. The superficial gas velocity in the gas phase reactor has been selected to be 0.45 m/s.

A cyclone has been placed (it is possible to overcome it) at the exit of the disengagement zone (recirculation gas pipe) to collect the entrained particles (estimate the particles carry over) as well as to prevent small size particles going through the gas compressor and heat exchanger.

The catalyst productivity in GPR was 1.5 kg/gcat (3 days average). The production split value was equal to 58%. Based on ΔP measurements across the fluidized bed (i.e., ΔP=rho*g*hbed), the fluidized bulk density was measured equal to 260 kg/m3. The utilized catalyst particles had i) a ratio of Weibull modulus to scale parameter equal to 0.55 and ii) a value of the product between the Weibull modulus and the scale parameter equal to 22. It has been measured that the solids carry over has been equal to 160 kg/h. Moreover, after 7 days of operation significant agglomeration issues have been experienced resulted in severe operability issues. The operation of GPR has been interrupted and finally led to shut down after 10 days of operation due to sheeting and chunking issues.

### Inventive Process Example 1 (IPE1/IE2)

The procedure of Example 1 was repeated with the exception that a different single-site catalyst (IE2) was employed having initial size d50 of 25 μm. The productivity was 1.5 kg/gcat while the catalyst productivity in GPR was 1.9 kg/gcat. The production split value was equal to 58%. Based on ΔP measurements across the fluidized bed, the fluidized bulk density was measured equal to 380 kg/m3. The utilized catalyst particles had i) a ratio of Weibull modulus to scale parameter equal to 0.49 and ii) a value of the product between the Weibull modulus and the scale parameter equal to 47. It has been measured that the solids carry over has been equal to 5 kg/h. The operation of GPR has been smooth for 20 days of operation.

### Inventive Process Example 2 (IPE2/IE3)

The procedure of Example 1 was repeated with the exception that a different single-site catalyst (IE3) was employed having initial size d50 of 25 μm. The productivity was 1.5 kg/gcat while the catalyst productivity in GPR was 2.1 kg/gcat. The production split value was equal to 58%. Based on ΔP measurements across the fluidized bed, the fluidized bulk density was measured equal to 390 kg/m3. The utilized catalyst particles had i) a ratio of Weibull modulus to scale parameter equal to 0.43 and ii) a value of the product between the Weibull modulus and the scale parameter equal to 61. It has been measured that the solids carry over has been equal to 4.0 kg/h. The operation of GPR has been smooth for 20 days of operation.

TABLE 1
1-step procedure catalyst examples

| Example | CE3 | CE5 | IE1 | IE2 | IE3 | IE4 |
|---|---|---|---|---|---|---|
| SiO2 loading (kg) | 5 | 10 | 5 | 5 | 5 | 12 |
| MC loading (mmol/kg | 70.0 | 70.0 | 84.0 | 70.0 | 126.0 | 70.0 |
| SiO2) | | | | | | |
| MAO loading (mol/kg | 7.0 | 7.0 | 8.4 | 9.8 | 9.8 | 9.8 |
| SiO2) | | | | | | |
| Pre-contact time (hours) | 3 | 3 | 3 | 3 | 3 | 3 |
| Pre-contact temperature | 25 | 25 | 25 | 25 | 25 | 25 |
| (° C.) | | | | | | |
| Impregnation stir-out time | 1 | 1 | 1 | 1 | 1 | 2 |
| (hours) | | | | | | |
| Impregnation temperature | 10 | 10 | 10 | 10 | 10 | 8 |
| (° C.) | | | | | | |
| Stabilisation time (hours) | 12 | 12 | 12 | 12 | 12 | 12 |
| Stabilisation temperature | 25 | 25 | 25 | 25 | 25 | 25 |
| (° C.) | | | | | | |
| N2 drying temperature | 60 | 60 | 60 | 60 | 60 | 60 |
| (° C.) | | | | | | |
| N2 drying time (hours) | 2 | 2 | 2 | 2 | 2 | 2 |
| vacuum drying time (hours) | 8 | 13 | 8 | 8 | 8 | 16 |
| Vacuum drying temperature | 60 | 60 | 60 | 60 | 60 | 60 |
| (° C.) | | | | | | |
| Solid catalyst outtake (kg) | 6.44 | 14.09 | 7.61 | 7.91 | 8.25 | 19.30 |

TABLE 2
2-steps procedure catalyst examples

| Example | CE2 | CE4 |
|---|---|---|
| SiO2 loading (kg) | 5 | 5 |
| MC loading | 61.3 | 61.3 |
| mmol/kg SiO2 | | |
| MAO loading | 8.7 | 8.7 |
| mol/kg SiO2 | | |
| SiO2/MAO impregnation | 90.0 | 90.0 |
| temperature (° C.) | | |
| SiO2/MAO stir-out time (min) | 120.0 | 120.0 |
| 1st toluene wash temperature | 95.0 | 95.0 |
| (° C.) | | |
| 2nd toluene wash temperature | 65.0 | 65.0 |
| (° C.) | | |
| Drying temperature (° C.) | 60.0 | 60.0 |
| N2 drying time (hours) | 2.0 | 2.0 |
| vacuum drying time (hours) | 6.0 | 6.0 |
| Impregnation temperature (° C.) | 80.0 | 80.0 |
| Impregnation stir-out time (min) | 60 | 60 |
| Stir-out temperature (° C.) | 25 | 60 |
| Stabilisation time (hours) | 12 | 0 |
| Stabilisation temperature (° C.) | 25 | |
| N2 drying temperature (° C.) | 60 | 60 |
| N2 drying time (hours) | 2 | 2 |
| vacuum drying time (hours) | 7 | 8 |
| Solid catalyst outtake (kg) | 6.98 | 6.56 |

TABLE 3A
Analytics and characterisation

| | SiO2 loading | MC loading | MAO loading | MC | MAO |
|---|---|---|---|---|---|
| Ex. | kg | mmol/kg SiO2 | mol/kg SiO2 | mmol/kg SiO2 | mol/kg SiO2 |
| CE1 | 0.00 | 0.00 | 0.00 | 0.00 | 0.00 |
| CE2 | 5.00 | 61.32 | 8.73 | 60.56 | 7.56 |
| CE3 | 5.00 | 70.00 | 7.00 | 57.16 | 6.72 |
| CE4 | 5.00 | 61.32 | 8.73 | 48.67 | 7.66 |
| CE5 | 10.00 | 70.00 | 7.00 | 79.22 | 7.17 |
| IE1 | 5.00 | 84.00 | 8.40 | 74.83 | 7.79 |
| IE2 | 5.00 | 70.00 | 9.80 | 80.37 | 9.77 |
| IE3 | 5.00 | 126.00 | 9.80 | 137.79 | 9.20 |
| IE4 | 5.00 | 70.00 | 9.80 | 79.535 | 9.38 |

TABLE 3B
Analytics and characterisation

| | Compressive | | | | |
|---|---|---|---|---|---|
| | strength | Weibull | Weibull scale | Modulus/scale | Modulus*scale |
| Ex. | MPa | modulus | MPa | MPa⁻¹ | MPa |
| CE1 | 3.50 | 3.54 | 3.88 | 0.91 | 13.72 |
| CE2 | 8.77 | 3.73 | 9.67 | 0.39 | 36.02 |
| CE3 | 7.40 | 4.74 | 8.07 | 0.59 | 38.25 |
| CE4 | 7.14 | 3.43 | 7.94 | 0.43 | 27.24 |
| CE5 | 5.65 | 3.48 | 6.30 | 0.55 | 21.92 |
| IE1 | 9.20 | 4.75 | 9.98 | 0.48 | 47.39 |
| IE2 | 8.97 | 4.83 | 9.78 | 0.49 | 47.22 |
| IE3 | 10.96 | 5.10 | 11.94 | 0.43 | 60.91 |
| IE4 | 10.01 | 4.12 | 11.16 | 0.37 | 46.02 |

TABLE 4
Polymerisation data

| | BSR Activity | BSR Bulk |
|---|---|---|
| Example | kg_{polymer}/g_{cat} · h | density |
| CE2 | 2.82 | 0.44 |
| CE3 | 3.02 | 0.37 |
| CE4 | 3.33 | 0.41 |
| CE5 | 2.80 | 0.38 |
| IE1 | 3.14 | 0.41 |
| IE2 | 3.81 | 0.42 |
| IE3 | 3.92 | 0.43 |
| IE4 | 3.50 | 0.45 |

TABLE 5
Continuous process polymerisation

| | | Loop productivity | Total productivity | Loop | Total |
|---|---|---|---|---|---|
| Example | Catalyst | kg_{polymer}/g_{cat} × h | kg_{polymer}/g_{cat} × h | BD | BD |
| CPE1 | CE5 | 1.09 | 2.59 | 0.42 | 0.46 |
| IPE1 | IE2 | 1.46 | 3.40 | 0.43 | 0.46 |
| IPE2 | IE3 | 1.48 | 3.57 | 0.44 | 0.46 |

1. A process for polymerising olefins, the process comprising
polymerising ethylene, optionally in the presence of at least one other alpha olefin comonomer, in the presence of a single-site polymerisation catalyst to produce a polymer component, a polyethylene polymer, or a polyethylene copolymer,
wherein the single-site polymerisation catalyst comprises (i) a transition metal complex; (ii) a cocatalyst; and optionally (iii) a support; and
is characterised by:
a (Weibull modulus)×(scale parameter) product equal to or higher than 40 MPa, and
a (Weibull modulus)/(scale parameter) ratio equal to or lower than 0.50 MPa⁻¹,
wherein the Weibull modulus and the scale parameter are determined as described in the experimental part by the Weibull analysis of the compressive strength of the catalyst particles.

2. The process of claim 1, wherein the process comprises polymerising olefins in a multi stage polymerisation process configuration, the process comprising
a) polymerising in a first polymerisation step ethylene, optionally in the presence of at least one other alpha olefin comonomer, and the single-site polymerisation catalyst, so as to form a first polymer component (A); and
b) polymerising in a second polymerisation step an olefin monomer, optionally in the presence of at least one other alpha olefin comonomer, in the presence of the first polymer component (A) of step a), so as to form a second polymer component (B),
to produce a polyethylene polymer or a polyethylene copolymer,
wherein the single-site polymerisation catalyst comprises (i) a transition metal complex; (ii) a cocatalyst; and optionally (iii) a support; and
is characterised by:
a (Weibull modulus)×(scale parameter) product equal to or higher than 40 MPa, and
a (Weibull modulus)/(scale parameter) ratio equal to or lower than 0.50 MPa⁻¹,
wherein the Weibull modulus and the scale parameter are determined as described in the experimental part by the Weibull analysis of the compressive strength of the catalyst particles.

3. The process as claimed in claim 1, wherein the ratio of the cocatalyst (ii) to the transition metal complex (i) is greater than 50 mol/mol.

4. The process as claimed in claim 1, wherein the transition metal complex is a metallocene complex of formula (I) 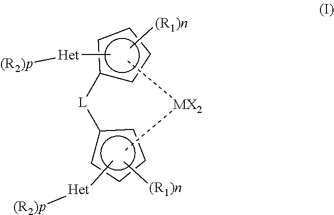
wherein
each X is a sigma donor ligand;
each Het is independently a monocyclic or multicyclic heteroaromatic or heterocyclic group containing at least one heteroatom selected from O, N, or S;
L is a carbon, silicon or germanium based divalent bridge in which one or two backbone atoms link the ligands;
M is Ti, Zr, or Hf;
each R₁ is the same or different and is a C₁₋₁₀ alkyl group, C₁₋₁₀ alkoxy, benzyl, O-benzyl, phenyl group optionally substituted by 1 to 3 C₁₋₆ alkyl groups, or O-phenyl group optionally substituted by 1 to 3 C₁₋₆ alkyl groups; and/or
two adjacent R₁ groups taken together with the atoms to which they are bound form a further ring, which further ring is optionally substituted by up to 4 groups R₃;
each R₃ is the same or different and is a C₁₋₁₀ alkyl group, C₁₋₁₀ alkoxy group, or phenyl group optionally substituted by 1 to 3 C₁₋₆ alkyl groups;
each n is 0 to 3;
each R₂ is the same or different and is a C₁₋₁₀ alkyl group, C₁₋₁₀ alkoxy group or —Si(R)₃ group;
each R is C₁₋₁₀ alkyl or phenyl group optionally substituted by 1 to 3 C₁₋₆ alkyl groups; and
each p is 0 to 3.

5. The process as claimed in claim 4, wherein the metallocene complex is of formula (X) 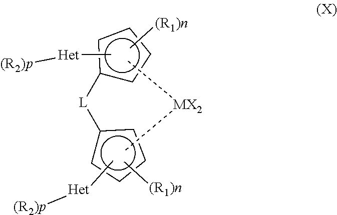
wherein
each X is independently a hydrogen atom, a halogen atom, a C₁₋₆-alkyl, C₁₋₆-alkoxy group, amido, phenyl, or benzyl group;
L is a —R′₂Si—, wherein each R′ is independently C₁₋₂₀ hydrocarbyl or C₁₋₁₀ alkyl substituted with alkoxy having 1 to 10 carbon atoms;
M is Ti, Zr, or Hf;
each Het is independently a monocyclic heteroaromatic or heterocyclic group containing at least one heteroatom selected from O, N, or S;
each R₁ is the same or different and is a C₁₋₁₀ alkyl group;
each n is 1 to 3;
each R₂ is the same or different and is a —Si(RaRbRc) group;
Ra is C₁₋₆ alkyl;
Rb is C₁₋₆ alkyl;
Rc is a phenyl group optionally substituted by 1 to 3 C₁₋₆ alkyl group; and
each p is 1 to 3.

6. The process as claimed in claim 4, wherein the metallocene complex (i) is of formula (XII′) 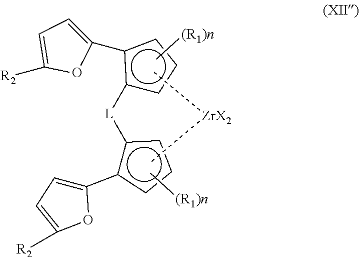
wherein
each X is independently a hydrogen atom, a halogen atom, a C₁₋₆-alkyl, C₁₋₆-alkoxy group, amido, phenyl, or benzyl group;
L is a (RdRe)Si group;
Rd is a C₁₋₁₀ alkyl group;
Re is a C₂₋₁₀ alkenyl group;
each R₁ is the same or different and is a C₁₋₁₀ alkyl group;
each n is 1 to 3;
each R₂ is the same or different and is a —Si(R)₃ group;
each R is C₁₋₁₀ alkyl or phenyl group optionally substituted by 1 to 3 C₁₋₆ alkyl groups.

7. The process as claimed in claim 2, wherein step a) is performed in at least two slurry reactors.

8. The process as claimed in claim 2, wherein step a) is performed in at least three slurry reactors.

9. A single-site polymerisation catalyst, comprising
(i) a transition metal complex;
(ii) a cocatalyst; and
optionally (iii) a support, preferably a silica support;
wherein the single-site polymerisation catalyst is characterised by;
a (Weibull modulus)×(scale parameter) product equal to or higher than 40 MPa, and
a (Weibull modulus)/(scale parameter) ratio equal to or lower than 0.50 MPa⁻¹,
wherein the Weibull modulus and the scale parameter are determined as described in the experimental part by the Weibull analysis of the compressive strength of the catalyst particles.

10. The single-site polymerisation catalyst as claimed in claim 9, wherein the ratio of the cocatalyst (ii) to the transition metal complex (i) is greater than 50 mol/mol.

11. The single-site polymerisation catalyst as claimed in claim 9, wherein the cocatalyst (ii) is of formula (i-I): 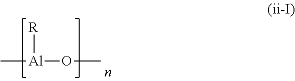
where n is from 6 to 20 and R is C1-C10-alkyl, or C3-C10-cycloalkyl, C7-C12-arylalkyl or -alkylaryl and/or phenyl or naphthyl.

12. The single-site polymerisation catalyst as claimed in claim 9, wherein the transition metal complex is a metallocene complex of formula (I) 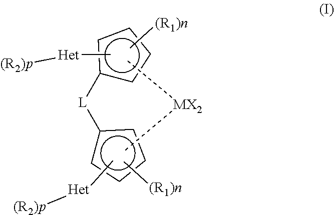
wherein
each X is a sigma donor ligand;
each Het is independently a monocyclic or multicyclic heteroaromatic or heterocyclic group containing at least one heteroatom selected from O, N, or S;
L is a carbon, silicon or germanium based divalent bridge in which one or two backbone atoms link the ligands;
M is Ti, Zr, or Hf;
each R₁ is the same or different and is a C₁₋₁₀ alkyl group, C₁₋₁₀ alkoxy, benzyl, O-benzyl, phenyl group optionally substituted by 1 to 3 C₁₋₆ alkyl groups, or O-phenyl group optionally substituted by 1 to 3 C₁₋₆ alkyl groups; and/or
two adjacent R₁ groups taken together with the atoms to which they are bound form a further ring, which further ring is optionally substituted by up to 4 groups R₃;
each R₃ is the same or different and is a C₁₋₁₀ alkyl group, C₁₋₁₀ alkoxy group, or phenyl group optionally substituted by 1 to 3 C₁₋₆ alkyl groups;
each n is 0 to 3;
each R₂ is the same or different and is a C₁₋₁₀ alkyl group, C₁₋₁₀ alkoxy group or —Si(R)₃ group;
each R is C₁₋₁₀ alkyl or phenyl group optionally substituted by 1 to 3 C₁₋₆ alkyl groups; and
each p is 0 to 3.

13. The single-site polymerisation catalyst as claimed in claim 9, wherein the transition metal complex is a metallocene complex of formula (X) 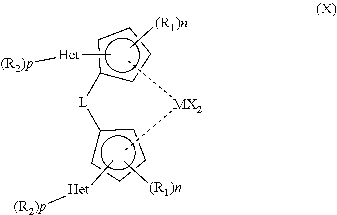
wherein
each X is independently a hydrogen atom, a halogen atom, a C₁₋₆-alkyl, C₁₋₆-alkoxy group, amido, phenyl, or benzyl group;
L is a —R′₂Si—, wherein each R′ is independently C₁₋₂₀ hydrocarbyl or C₁₋₁₀ alkyl substituted with alkoxy having 1 to 10 carbon atoms;
M is Ti, Zr, or Hf;
each Het is independently a monocyclic heteroaromatic or heterocyclic group containing at least one heteroatom selected from O, N or S;
each R₁ is the same or different and is a C₁₋₁₀ alkyl group;
each n is 1 to 3;
each R₂ is the same or different and is a —Si(RaRbRc) group;
Ra is C₁₋₆ alkyl;
Rb is C₁₋₆ alkyl;
Re is a phenyl group optionally substituted by 1 to 3 C₁₋₆ alkyl group; and
each p is 1 to 3.

14. The single-site polymerisation catalyst as claimed in claim 12, wherein the metallocene complex (i) is of formula (XII′) 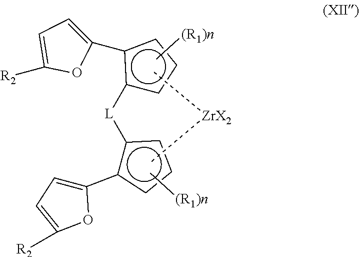
wherein
each X is independently a hydrogen atom, a halogen atom, a C₁₋₆-alkyl, C₁₋₆-alkoxy group, amido, phenyl or benzyl group;
L is a (RdRe)Si group;
Rd is a C₁₋₁₀ alkyl group;
Re is a C₂₋₁₀ alkenyl group;
each R₁ is the same or different and is a C₁₋₁₀ alkyl group;
each n is 1 to 3;
each R₂ is the same or different and is a —Si(R)₃ group;
each R is C₁₋₁₀ alkyl or phenyl group optionally substituted by 1 to 3 C₁₋₆ alkyl groups.

15. A method of use of the single-site polymerisation catalyst claimed in claim 9, the method comprising using the single-site polymerisation catalyst in the preparation of a polyethylene polymer component, a polyethylene polymer, or a polyethylene copolymer.

16. The process of claim 2, wherein step a) is performed in slurry phase.

17. The process of claim 2, wherein step b) is performed in gas phase.

18. The process of claim 1, wherein the ratio of the cocatalyst (ii) to the transition metal complex (i) is from 60 to 200 mol/mol.

19. The single-site polymerisation catalyst of claim 11, wherein R is C1-C5-alkyl.

20. The single-site polymerisation catalyst of claim 9, wherein the cocatalyst (ii) is MAO.
